(19) United States
(12) Patent Application Publication
(10) Pub. No.: US 2017/0071021 A1
(43) Pub. Date: Mar. 9, 2017

(54) WIRELESS COMMUNICATION METHOD AND WIRELESS TERMINAL

(71) Applicant: HUAWEI DEVICE CO., LTD., Shenzhen (CN)

(72) Inventors: Hui JIN, Beijing (CN); Xiaoyan DUAN, Beijing (CN); Li SHEN, Beijing (CN); Peng WANG, Beijing (CN); Guoqiong CAO, Beijing (CN); Songping YAO, Beijing (CN); Hao SONG, Beijing (CN); Bo ZHANG, Beijing (CN)

(73) Assignee: HUAWEI DEVICE CO., LTD., Shenzhen (CN)

(21) Appl. No.: 15/123,181

(22) PCT Filed: Apr. 26, 2014
(86) PCT No.: PCT/CN2014/076302

§ 371 Date: Sep. 1, 2016

(30) Foreign Application Priority Data
Mar. 24, 2014 (CN) PCT/CN2014/073974

(51) Int. Cl. H04W 76/02; H04W 76/04

(52) U.S. Cl. CPC H04W 76/025; H04W 76/046; H04W 88/06

(57) ABSTRACT

A wireless communication method and a wireless terminal. A wireless terminal supports a first radio access technology (RAT) and a second RAT. The wireless terminal establishes a connection with a second RAT network. The wireless terminal receives a first message sent by the second RAT network. The first message includes content used to query a first RAT capability of the wireless terminal. The wireless terminal sends a second message to the second RAT network. The second message is used to indicate that the wireless terminal does not support the first RAT.

### CROSS REFERENCE TO RELATED APPLICATIONS

This application is a National Stage of International Application No. PCT/CN2014/076302, filed on Apr. 26, 2014, which claims priority to International Application No. PCT/CN2014/073974, filed on Mar. 24, 2014, both of which are hereby incorporated by reference in their entireties.

### TECHNICAL FIELD

The present disclosure relates to wireless communication technologies, and in particular, to a wireless communication method and a wireless terminal.

### BACKGROUND

With development of network technologies, a 4G (4th-generation mobile communication technology) is extensively applied. 4G may include multiple network standards, for example, LTE (Long Term Evolution)-TDD (Time Division Duplexing), and LTE-FDD (Frequency Division Duplex).

A 4G network provides only a packet switched domain (PS domain) service, and cannot provide a circuit switched domain (CS domain) service. However, 2G and 3G networks support both the PS domain service and CS domain service. Currently, a voice service and a short message service are mainly provided by a CS domain, and a data service is mainly provided by a PS domain. To support both the PS domain service and CS domain service, a dual-standby technology is currently used when the 4G network is deployed. A wireless terminal using the dual-standby technology has two radio frequency modules. One radio frequency module is a master radio frequency module mainly configured to provide the PS domain service, and the master radio frequency module provides support for the 4G network. The other radio frequency module is a slave radio frequency module, and the slave radio frequency module is mainly configured to provide the CS domain service.

In a process of performing the PS domain service by the wireless terminal using the dual-standby technology, when there is a 4G signal, the wireless terminal works in the 4G network; when the 4G signal is weak, the wireless terminal is changed to the 2G or 3G network, and when the 4G signal recovers to normal, the wireless terminal is changed to the 4G network again. Currently, an inappropriate configuration of the 4G network causes frequent changes of the wireless terminal between 4G and 2G/3G, and results in heavy network load and poor user experience.

### SUMMARY

Embodiments of the present disclosure provide a wireless communication method and a wireless terminal, which can reduce the number of changes of the wireless terminal between 4G and 2G/3G, reduce network load, and enhance user experience.

According to a first aspect, a wireless communication method is provided, where the method includes:

after a wireless terminal supporting a first radio access technology (RAT) and a second RAT establishes a connection with a second RAT network, receiving, by the wireless terminal, a first message sent by the second RAT network, where the first message includes content used to query a first RAT capability of the wireless terminal; and

sending, by the wireless terminal, a second message to the second RAT network, where the second message is used to indicate that the wireless terminal does not support the first RAT.

In a first possible implementation manner of the first aspect, the sending, by the wireless terminal, a second message to the second RAT network, specifically includes:

sending, by the wireless terminal, the second message to the second RAT network when the wireless terminal is in a dual-standby mode.

In a second possible implementation manner of the first aspect, the sending, by the wireless terminal, a second message to the second RAT network, specifically includes:

sending, by the wireless terminal, the second message to the second RAT network when the wireless terminal is in a dual-standby mode; and

sending, by the wireless terminal, a third message to the second RAT network when the wireless terminal is in a circuit domain fallback mode, where the third message is used to indicate that the wireless terminal supports the first RAT.

With reference to the first or second possible implementation manner of the first aspect, in a third possible implementation manner,

the sending, by the wireless terminal, the second message to the second RAT network when the wireless terminal is in a dual-standby mode, specifically includes: when a public land mobile network (PLMN) identifier of a second RAT cell on which the wireless terminal camps is in an operator controlled PLMN selector list stored by the wireless terminal, sending, by the wireless terminal, the second message to the second RAT network; and

the sending, by the wireless terminal, a third message to the second RAT network when the wireless terminal is in a circuit domain fallback mode, specifically includes: when the public land mobile network PLMN identifier of the second RAT cell on which the wireless terminal camps is not in the operator controlled PLMN selector list stored by the wireless terminal, sending, by the wireless terminal, the third message to the second RAT network.

With reference to the first aspect or any one of the foregoing possible implementation manners of the first aspect, in a fourth possible implementation manner,

the second message does not include the first RAT capability; or

the second message includes an identifier used to indicate that the wireless terminal does not support the first RAT.

With reference to the first aspect or any one of the foregoing possible implementation manners of the first aspect, in a fifth possible implementation manner, the method further includes:

after the wireless terminal establishes the connection with the second RAT network, skipping, by the wireless terminal, detecting a signal strength corresponding to the first RAT.

With reference to the first aspect or any one of the foregoing possible implementation manners of the first aspect, in a sixth possible implementation manner, before the receiving, by the wireless terminal, a first message sent by the second RAT network, the method further includes:

reestablishing, by the wireless terminal, a connection with the second RAT network after the wireless terminal receives a fourth message that is sent by the second RAT network and carries a redirect indication, where the fourth message is used to instruct to redirect the wireless terminal from the second RAT network to the first RAT network; and

sending, by the wireless terminal, a fifth message to a second RAT network management entity, so that the second RAT network management entity triggers the second RAT network to send the first message to the wireless terminal.

With reference to the sixth possible implementation manner of the first aspect, in a seventh possible implementation manner, the reestablishing, by the wireless terminal, a connection with the second RAT network after the wireless terminal receives a fourth message that is sent by the second RAT network and carries a redirect indication, specifically includes:

reestablishing, by the wireless terminal, the connection with the second RAT network when the wireless terminal receives the fourth message that is sent by the second RAT network and carries the redirect indication and a signal strength that is detected by the wireless terminal and corresponding to the second RAT is higher than or equal to a first threshold.

With reference to the first aspect or any one of the foregoing possible implementation manners of the first aspect, in an eighth possible implementation manner, the first RAT includes a 2G packet domain and/or 3G, and the second RAT is 4G; and the connection established by the wireless terminal with the second RAT network is a radio resource control (RRC) connection.

According to a second aspect, a wireless communication method is provided, where the method includes:

after a wireless terminal supporting a first radio access technology RAT and a second RAT establishes a connection with a second RAT network, receiving, by the wireless terminal, a fourth message that is sent by the second RAT network and carries a redirect indication, where the fourth message is used to instruct to redirect the wireless terminal from the second RAT network to the first RAT network; and

reestablishing, by the wireless terminal, a connection with the second RAT network.

In a first possible implementation manner of the second aspect, the reestablishing, by the wireless terminal, a connection with the second RAT network, specifically includes:

reestablishing, by the wireless terminal, the connection with the second RAT network when the wireless terminal is in a dual-standby mode.

In a second possible implementation manner of the second aspect, the reestablishing, by the wireless terminal, a connection with the second RAT network, specifically includes:

reestablishing, by the wireless terminal, the connection with the second RAT network when a signal strength that is detected by the wireless terminal and corresponding to the second RAT is higher than or equal to a first threshold.

With reference to the second aspect or any one of the foregoing possible implementation manners of the second aspect, in a third possible implementation manner,

the first RAT includes 2G and/or 3G, and the second RAT is 4G; and

the connection established by the wireless terminal with the second RAT network is a radio resource control RRC connection.

According to a third aspect, a wireless communication method is provided, where the method includes:

after a wireless terminal supporting a first radio access technology RAT and a second RAT establishes a connection with a second RAT network, receiving, by the wireless terminal, a measurement configuration sent by the second RAT network, where the measurement configuration is used to configure the wireless terminal to send a measurement report to the second RAT network under a preset condition; and

sending, by the wireless terminal, a measurement report to the second RAT network when the preset condition is met;

where, the measurement report includes: a processed first signal strength corresponding to the first RAT and/or a processed second signal strength corresponding to the second RAT, where the first signal strength is lower than a signal strength that is detected by the wireless terminal and corresponding to the first RAT, and the second signal strength is higher than a signal strength that is detected by the wireless terminal and corresponding to the second RAT.

In a first possible implementation manner of the third aspect, the sending, by the wireless terminal, a measurement report to the second RAT network when the preset condition is met, specifically includes:

sending, by the wireless terminal, the measurement report to the second RAT network when the preset condition is met, the signal strength corresponding to the second RAT is lower than or equal to a second threshold, and the signal strength corresponding to the second RAT is higher than or equal to a third threshold, where the second threshold is higher than the third threshold.

With reference to the third aspect or the first possible implementation manner of the third aspect, in a second possible implementation manner,

the first signal strength is obtained in the following manner: obtaining the first signal strength by subtracting a first preset value from the signal strength that is detected by the wireless terminal and corresponding to the first RAT, or obtaining the first signal strength by subtracting a first preset amplitude from the signal strength that is detected by the wireless terminal and corresponding to the first RAT, or using a fourth threshold as the first signal strength, where the fourth threshold is lower than the signal strength that is detected by the wireless terminal and corresponding to the first RAT; and

the second signal strength is obtained in the following manner: obtaining the second signal strength by adding a second preset value to the signal strength that is detected by the wireless terminal and corresponding to the second RAT, or obtaining the second signal strength by adding a second preset amplitude to the signal strength that is detected by the wireless terminal and corresponding to the second RAT, or using a fifth threshold as the second signal strength, where the fifth threshold is higher than the signal strength that is detected by the wireless terminal and corresponding to the second RAT.

With reference to the third aspect, in a third possible implementation manner of the third aspect, the sending, by the wireless terminal, a measurement report to the second RAT network when the preset condition is met, specifically includes:

sending, by the wireless terminal, the measurement report to the second RAT network when the preset condition is met and the wireless terminal is in a dual-standby mode.

With reference to the third aspect or any one of the foregoing possible implementation manners of the third aspect, in a fourth possible implementation manner,

the first RAT includes 2G and/or 3G, and the second RAT is 4G; and

the connection established by the wireless terminal with the second RAT network is a radio resource control RRC connection.

According to a fourth aspect, a wireless communication method is provided, where the method includes:

after a wireless terminal supporting a first radio access technology RAT and a second RAT establishes a connection with a second RAT network, receiving, by the wireless terminal, a measurement configuration sent by the second RAT network, where the measurement configuration is used to configure the wireless terminal to send a measurement report to the second RAT network under a preset condition, where the preset condition is: when a signal strength that is detected by the wireless terminal and corresponding to the first RAT is higher than or equal to a sixth threshold, the wireless terminal sends a measurement report corresponding to the first RAT, where the measurement report corresponding to the first RAT includes the signal strength that is detected by the wireless terminal and corresponding to the first RAT; and

when the signal strength that is detected by the wireless terminal and corresponding to the first RAT is higher than or equal to a seventh threshold, sending, by the wireless terminal, the measurement report corresponding to the first RAT to the second RAT network, where the seventh threshold is higher than the sixth threshold.

In a first possible implementation manner of the fourth aspect,

the seventh threshold is a preset fixed value; or the seventh threshold is the sixth threshold plus a third preset value; or the seventh threshold is the sixth threshold plus a third preset amplitude.

With reference to the fourth aspect or the first possible implementation manner of the fourth aspect, in a second possible implementation manner,

the first RAT includes 2G and/or 3G, and the second RAT is 4G; and

the connection established by the wireless terminal with the second RAT network is a radio resource control RRC connection.

According to a fifth aspect, a wireless communication method is provided, where the method includes:

after a wireless terminal supporting a first radio access technology RAT and a second RAT establishes a connection with a second RAT network, receiving, by the wireless terminal, a measurement configuration sent by the second RAT network, where the measurement configuration is used to configure the wireless terminal to send a measurement report to the second RAT network under a preset condition, where the preset condition is: when a signal strength that is detected by the wireless terminal and corresponding to the second RAT is lower than or equal to an eighth threshold, the wireless terminal sends a measurement report corresponding to the second RAT, where the measurement report corresponding to the second RAT includes the signal strength that is detected by the wireless terminal and corresponding to the second RAT; and

when the signal strength that is detected by the wireless terminal and corresponding to the second RAT is lower than or equal to a ninth threshold, sending, by the wireless terminal, the measurement report corresponding to the second RAT to the second RAT network, where the ninth threshold is lower than the eighth threshold.

In a first possible implementation manner of the fifth aspect,

the ninth threshold is a preset fixed value; or the ninth threshold is the eighth threshold decreased by a fourth preset value; or the ninth threshold is the eighth threshold decreased by a fourth preset amplitude.

With reference to the fifth aspect or the first possible implementation manner of the fifth aspect, in a second possible implementation manner,

the first RAT includes 2G and/or 3G, and the second RAT is 4G; and

the connection established by the wireless terminal with the second RAT network is an RRC connection.

According to a sixth aspect, a wireless communication method is provided, where the method includes:

after a wireless terminal supporting a first radio access technology RAT and a second RAT establishes a connection with a second RAT network, receiving, by the wireless terminal, a measurement configuration sent by the second RAT network, where the measurement configuration is used to configure the wireless terminal to send a measurement report to the second RAT network under a preset condition, where the measurement report includes signal strengths that are detected by the wireless terminal and respectively corresponding to the first RAT and second RAT; and

when the preset condition is met, sending, by the wireless terminal, a measurement report corresponding to the second RAT to the second RAT network, and skipping, by the wireless terminal, sending a measurement report corresponding to the first RAT to the second RAT network.

In a first possible implementation manner of the sixth aspect, the skipping, by the wireless terminal, sending a measurement report corresponding to the first RAT to the second RAT network when the preset condition is met, specifically includes:

skipping, by the wireless terminal, sending the measurement report corresponding to the first RAT to the second RAT network when the preset condition is met and the wireless terminal is in a dual-standby mode.

With reference to the sixth aspect or the first possible implementation manner of the sixth aspect, in a second possible implementation manner,

the first RAT includes 2G and/or 3G, and the second RAT is 4G; and

the connection established by the wireless terminal with the second RAT network is a radio resource control RRC connection.

According to a seventh aspect, a wireless terminal is provided, where the wireless terminal supports a first radio access technology RAT and a second RAT, and the wireless terminal includes a radio transceiver module and a processor, where:

the radio transceiver module is configured to perform wireless communication externally;

the processor is configured to receive, by using the radio transceiver module after the wireless terminal establishes a connection with a second RAT network, a first message sent by the second RAT network, where the first message includes content used to query a first RAT capability of the wireless terminal; and

the processor is further configured to send a second message to the second RAT network by using the radio transceiver module, where the second message is used to indicate that the wireless terminal does not support the first RAT.

In a first possible implementation manner of the seventh aspect, when the second message is sent to the second RAT network by using the radio transceiver module, the processor is specifically configured to: send the second message to the second RAT network by using the radio transceiver module when the wireless terminal is in a dual-standby mode.

In a second possible implementation manner of the seventh aspect, when the second message is sent to the second RAT network by using the radio transceiver module, the processor is specifically configured to:

send the second message to the second RAT network by using the radio transceiver module when the wireless terminal is in a dual-standby mode; and

send a third message to the second RAT network by using the radio transceiver module when the wireless terminal is in a circuit domain fallback mode, where the third message is used to indicate that the wireless terminal supports the first RAT.

With reference to the seventh aspect or any one of the foregoing possible implementation manners of the seventh aspect, in a third possible implementation manner, the processor is further configured to:

reestablish a connection with the second RAT network before the first message sent by the second RAT network is received by using the radio transceiver module and after a fourth message that is sent by the second RAT network and carries a redirect indication is received by using the radio transceiver module, where the fourth message is used to instruct to redirect the wireless terminal from the second RAT network to the first RAT network; and

send a fifth message to a second RAT network management entity by using the radio transceiver module after the connection is reestablished with the second RAT network, so that the second RAT network management entity triggers the second RAT network to send the first message to the wireless terminal.

With reference to the third possible implementation manner of the seventh aspect, in a fourth possible implementation manner, when the connection is reestablished with the second RAT network, the processor is specifically configured to:

reestablish the connection with the second RAT network by the processor when a signal strength that is detected by the processor and corresponding to the second RAT is higher than or equal to a first threshold.

With reference to the seventh aspect or any one of the foregoing possible implementation manners of the seventh aspect, in a fifth possible implementation manner,

the first RAT includes a 2G packet domain and/or 3G, and the second RAT is 4G; and

the connection established by the wireless terminal with the second RAT network is a radio resource control RRC connection.

According to an eighth aspect, a wireless terminal is provided, where the wireless terminal supports a first radio access technology RAT and a second RAT, and the wireless terminal includes a radio transceiver module and a processor, where:

the radio transceiver module is configured to perform wireless communication externally;

the processor is configured to receive, by using the radio transceiver module after the wireless terminal establishes a connection with a second RAT network, a fourth message that is sent by the second RAT network and carries a redirect indication, where the fourth message is used to instruct to redirect the wireless terminal from the second RAT network to the first RAT network; and

the processor is further configured to reestablish a connection with the second RAT network after the fourth message that is sent by the second RAT network and carries the redirect indication is received.

In a first possible implementation manner of the eighth aspect, when the connection is reestablished with the second RAT network, the processor is specifically configured to: reestablish the connection with the second RAT network when the wireless terminal is in a dual-standby mode after the fourth message that is sent by the second RAT network and carries the redirect indication is received.

In a second possible implementation manner of the eighth aspect, when the connection is reestablished with the second RAT network, the processor is specifically configured to: reestablish the connection with the second RAT network when a signal strength that is detected by the wireless terminal and corresponding to the second RAT is higher than or equal to a first threshold after the fourth message that is sent by the second RAT network and carries the redirect indication is received.

With reference to the eighth aspect or any one of the foregoing possible implementation manners of the eighth aspect, in a third possible implementation manner,

the first RAT includes 2G and/or 3G, and the second RAT is 4G; and

the connection established by the wireless terminal with the second RAT network is a radio resource control RRC connection.

According to a ninth aspect, a wireless terminal is provided, where the wireless terminal supports a first radio access technology RAT and a second RAT, and the wireless terminal includes a radio transceiver module and a processor, where:

the radio transceiver module is configured to perform wireless communication externally;

the processor is configured to receive, by using the radio transceiver module after the wireless terminal establishes a connection with a second RAT network, a measurement configuration sent by the second RAT network, where the measurement configuration is used to configure the wireless terminal to send a measurement report to the second RAT network under a preset condition; and

the processor is further configured to send a measurement report to the second RAT network by using the radio transceiver module when the preset condition is met;

where, the measurement report includes: a processed first signal strength corresponding to the first RAT and/or a processed second signal strength corresponding to the second RAT, where the first signal strength is lower than a signal strength that is detected by the wireless terminal and corresponding to the first RAT, and the second signal strength is higher than a signal strength that is detected by the wireless terminal and corresponding to the second RAT.

In a first possible implementation manner of the ninth aspect, when the measurement report is sent to the second RAT network, the processor is specifically configured to: send the measurement report to the second RAT network by using the radio transceiver module when the preset condition is met, the signal strength corresponding to the second RAT is lower than or equal to a second threshold, and the signal strength corresponding to the second RAT is higher than or equal to a third threshold, where the second threshold is higher than the third threshold.

With reference to the ninth aspect or the first possible implementation manner of the ninth aspect, in a second possible implementation manner,

the first signal strength is obtained in the following manner: obtaining the first signal strength by subtracting a first preset value from the signal strength that is detected by the wireless terminal and corresponding to the first RAT, or obtaining the first signal strength by subtracting a first preset amplitude from the signal strength that is detected by the wireless terminal and corresponding to the first RAT, or using a fourth threshold as the first signal strength, where the fourth threshold is lower than the signal strength that is detected by the wireless terminal and corresponding to the first RAT; and

the second signal strength is obtained in the following manner: obtaining the second signal strength by adding a second preset value to the signal strength that is detected by the wireless terminal and corresponding to the second RAT, or obtaining the second signal strength by adding a second preset amplitude to the signal strength that is detected by the wireless terminal and corresponding to the second RAT, or using a fifth threshold as the second signal strength, where the fifth threshold is higher than the signal strength that is detected by the wireless terminal and corresponding to the second RAT.

With reference to the ninth aspect, in a third possible implementation manner of the ninth aspect, when the measurement report is sent to the second RAT network, the processor is specifically configured to: send the measurement report to the second RAT network by using the radio transceiver module when the preset condition is met and the wireless terminal is in a dual-standby mode.

With reference to the ninth aspect or any one of the foregoing possible implementation manners of the ninth aspect, in a fourth possible implementation manner,

the first RAT includes 2G and/or 3G, and the second RAT is 4G; and

the connection established by the wireless terminal with the second RAT network is a radio resource control RRC connection.

According to a tenth aspect, a wireless terminal is provided, where the wireless terminal supports a first radio access technology RAT and a second RAT, and the wireless terminal includes a radio transceiver module and a processor, where:

the radio transceiver module is configured to perform wireless communication externally;

the processor is configured to receive, by using the radio transceiver module after the wireless terminal establishes a connection with a second RAT network, a measurement configuration sent by the second RAT network, where the measurement configuration is used to configure the wireless terminal to send a measurement report to the second RAT network under a preset condition, where the preset condition is: when a signal strength that is detected by the wireless terminal and corresponding to the first RAT is higher than or equal to a sixth threshold, the wireless terminal sends a measurement report corresponding to the first RAT, where the measurement report corresponding to the first RAT includes the signal strength that is detected by the wireless terminal and corresponding to the first RAT; and

the processor is further configured to send the measurement report corresponding to the first RAT to the second RAT network by using the radio transceiver module when the signal strength that is detected by the wireless terminal and corresponding to the first RAT is higher than or equal to a seventh threshold, where the seventh threshold is higher than the sixth threshold.

In a first possible implementation manner of the tenth aspect,

the seventh threshold is a preset fixed value; or the seventh threshold is the sixth threshold plus a third preset value; or the seventh threshold is the sixth threshold plus a third preset amplitude.

With reference to the tenth aspect or the first possible implementation manner of the tenth aspect, in a second possible implementation manner,

the first RAT includes 2G and/or 3G, and the second RAT is 4G; and

the connection established by the wireless terminal with the second RAT network is a radio resource control (RRC) connection.

According to an eleventh aspect, a wireless terminal is provided, where the wireless terminal supports a first radio access technology RAT and a second RAT, and the wireless terminal includes a radio transceiver module and a processor, where:

the radio transceiver module is configured to perform wireless communication externally;

the processor is configured to receive, by using the radio transceiver module after the wireless terminal establishes a connection with a second RAT network, a measurement configuration sent by the second RAT network, where the measurement configuration is used to configure the wireless terminal to send a measurement report to the second RAT network under a preset condition, where the preset condition is: when a signal strength that is detected by the wireless terminal and corresponding to the second RAT is lower than or equal to an eighth threshold, the wireless terminal sends a measurement report corresponding to the second RAT, where the measurement report corresponding to the second RAT includes the signal strength that is detected by the wireless terminal and corresponding to the second RAT; and

the processor is further configured to send the measurement report corresponding to the second RAT to the second RAT network by using the radio transceiver module when the signal strength that is detected by the wireless terminal and corresponding to the second RAT is lower than or equal to a ninth threshold, where the ninth threshold is lower than the eighth threshold.

In a first possible implementation manner of the eleventh aspect,

the ninth threshold is a preset fixed value; or the ninth threshold is the eighth threshold decreased by a fourth preset value; or the ninth threshold is the eighth threshold decreased by a fourth preset amplitude.

With reference to the eleventh aspect or the first possible implementation manner of the eleventh aspect, in a second possible implementation manner,

the first RAT includes 2G and/or 3G, and the second RAT is 4G; and

the connection established by the wireless terminal with the second RAT network is a radio resource control RRC connection.

According to a twelfth aspect, a wireless terminal is provided, where the wireless terminal supports a first radio access technology RAT and a second RAT, and the wireless terminal includes a radio transceiver module and a processor, where:

the radio transceiver module is configured to perform wireless communication externally;

the processor is configured to receive, by using the radio transceiver module after the wireless terminal supporting the first radio access technology RAT and second RAT establishes a connection with a second RAT network, a measurement configuration sent by the second RAT network, where the measurement configuration is used to configure the wireless terminal to send a measurement report to the second RAT network under a preset condition, where the measurement report includes signal strengths that are detected by the wireless terminal and respectively corresponding to the first RAT and second RAT; and

the processor is further configured to: when the preset condition is met, send a measurement report corresponding to the second RAT to the second RAT network by using the radio transceiver module, and skip sending a measurement report corresponding to the first RAT to the second RAT network.

In a first possible implementation manner of the twelfth aspect, when the measurement report corresponding to the second RAT is sent to the second RAT network by using the radio transceiver module, the processor is specifically configured to:

when the wireless terminal is in a dual-standby mode and the preset condition is met, send the measurement report corresponding to the second RAT to the second RAT network by using the radio transceiver module, and skip sending the measurement report corresponding to the first RAT to the second RAT network.

With reference to the twelfth aspect or the first possible implementation manner of the twelfth aspect, in a second possible implementation manner,

the first RAT includes 2G and/or 3G, and the second RAT is 4G; and

the connection established by the wireless terminal with the second RAT network is a radio resource control RRC connection.

According to a thirteenth aspect, a wireless communication method is provided, where the method includes:

after a wireless communications device supporting a first RAT and a second RAT establishes a connection with a second RAT network, receiving, by the wireless communications device, a first message sent by the second RAT network, where the first message includes content used to query a first RAT capability of the wireless communications device; and

sending, by the wireless communications device, a second message to the second RAT network, where the second message is used to indicate that the wireless communications device does not support the first RAT.

In a first possible implementation manner of the thirteenth aspect, the sending, by the wireless communications device, a second message to the second RAT network, specifically includes:

sending, by the wireless communications device, the second message to the second RAT network when the wireless communications device is in a dual-standby mode.

In a second possible implementation manner of the thirteenth aspect, the sending, by the wireless communications device, a second message to the second RAT network, specifically includes:

sending, by the wireless communications device, the second message to the second RAT network when the wireless communications device is in a dual-standby mode; and

sending, by the wireless communications device, a third message to the second RAT network when the wireless communications device is in a circuit domain fallback mode, where the third message is used to indicate that the wireless communications device supports the first RAT.

With reference to the first or second possible implementation manner of the thirteenth aspect, in a third possible implementation manner,

the sending, by the wireless communications device, the second message to the second RAT network when the wireless communications device is in a dual-standby mode, specifically includes: when a public land mobile network PLMN identifier of a second RAT cell on which the wireless communications device camps is in an operator controlled PLMN selector list stored by the wireless communications device, sending, by the wireless communications device, the second message to the second RAT network; and

the sending, by the wireless communications device, a third message to the second RAT network when the wireless communications device is in a circuit domain fallback mode, specifically includes: when the public land mobile network PLMN identifier of the second RAT cell on which the wireless communications device camps is not in the operator controlled PLMN selector list stored by the wireless communications device, sending, by the wireless communications device, the third message to the second RAT network.

With reference to the thirteenth aspect or any one of the foregoing possible implementation manners of the thirteenth aspect, in a fourth possible implementation manner,

the second message does not include the first RAT capability; or

the second message includes an identifier used to indicate that the wireless communications device does not support the first RAT.

With reference to the thirteenth aspect or any one of the foregoing possible implementation manners of the thirteenth aspect, in a fifth possible implementation manner, the method further includes:

after the wireless communications device establishes the connection with the second RAT network, skipping, by the wireless communications device, detecting a signal strength corresponding to the first RAT.

With reference to the thirteenth aspect or any one of the foregoing possible implementation manners of the thirteenth aspect, in a sixth possible implementation manner, before the receiving, by the wireless communications device, a first message sent by the second RAT network, the method further includes:

reestablishing, by the wireless communications device, a connection with the second RAT network after the wireless communications device receives a fourth message that is sent by the second RAT network and carries a redirect indication, where the fourth message is used to instruct to redirect the wireless communications device from the second RAT network to the first RAT network; and

sending, by the wireless communications device, a fifth message to a second RAT network management entity, so that the second RAT network management entity triggers the second RAT network to send the first message to the wireless communications device.

With reference to the sixth possible implementation manner of the thirteenth aspect, in a seventh possible implementation manner, the reestablishing, by the wireless communications device, a connection with the second RAT network after the wireless communications device receives a fourth message that is sent by the second RAT network and carries a redirect indication, specifically includes:

reestablishing, by the wireless communications device, the connection with the second RAT network when the wireless communications device receives the fourth message that is sent by the second RAT network and carries the redirect indication and a signal strength that is detected by the wireless communications device and corresponding to the second RAT is higher than or equal to a first threshold.

With reference to the thirteenth aspect or any one of the foregoing possible implementation manners of the thirteenth aspect, in an eighth possible implementation manner, the first RAT includes a 2G packet domain and/or 3G, and the second RAT is 4G; and the connection established by the wireless communications device with the second RAT network is an RRC connection.

According to a fourteenth aspect, a wireless communications device is provided, where the wireless communications device supports a first RAT and a second RAT, and the wireless communications device includes:

a receiving module, configured to receive, after the wireless communications device establishes a connection with a second RAT network, a first message sent by the second RAT network, where the first message includes content used to query a first RAT capability of the wireless communications device; and

a sending module, configured to send a second message to the second RAT network, where the second message is used to indicate that the wireless communications device does not support the first RAT.

In a first possible implementation manner of the fourteenth aspect, the sending module is specifically configured to: send the second message to the second RAT network when the wireless communications device is in a dual-standby mode.

In a second possible implementation manner of the fourteenth aspect, the sending module is specifically configured to:

send the second message to the second RAT network when the wireless communications device is in a dual-standby mode; and

send a third message to the second RAT network when the wireless communications device is in a circuit domain fallback mode, where the third message is used to indicate that the wireless communications device supports the first RAT.

With reference to the fourteenth aspect or any one of the foregoing possible implementation manners of the fourteenth aspect, in a third possible implementation manner, the wireless communications device further includes:

a connecting module, configured to reestablish a connection with the second RAT network before the receiving module receives the first message sent by the second RAT network and after the receiving module receives a fourth message that is sent by the second RAT network and carries a redirect indication, where the fourth message is used to instruct to redirect the wireless communications device from the second RAT network to the first RAT network; where

the sending module is further configured to send a fifth message to a second RAT network management entity after the connecting module reestablishes the connection with the second RAT network, so that the second RAT network management entity triggers the second RAT network to send the first message to the wireless communications device.

With reference to the third possible implementation manner of the fourteenth aspect, in a fourth possible implementation manner, the connecting module is specifically configured to:

reestablish the connection with the second RAT network before the receiving module receives the first message sent by the second RAT network and when the receiving module receives the fourth message that is sent by the second RAT network and carries the redirect indication and a signal strength that is detected by the wireless communications device and corresponding to the second RAT is higher than or equal to a first threshold.

With reference to the fourteenth aspect or any one of the foregoing possible implementation manners of the fourteenth aspect, in a fifth possible implementation manner,

the first RAT includes a 2G packet domain and/or 3G, and the second RAT is 4G; and

the connection established by the wireless communications device with the second RAT network is an RRC connection.

In embodiments of the present disclosure, after a wireless terminal supporting a first RAT and a second RAT establishes a connection with a second RAT network, the wireless terminal may receive a first message that is sent by the second RAT network and used to query a first RAT capability of the wireless terminal; and the wireless terminal sends a second message to the second RAT network, where the second message is used to indicate that the wireless terminal does not support the first RAT. Because the wireless terminal reports that the wireless terminal does not support the first RAT to the second RAT network, the second RAT network does not instruct to change the wireless terminal to the first RAT. Therefore, the wireless terminal may work in the second RAT for a long time, the number of changes of the wireless terminal between the first RAT and the second RAT is reduced, network load is reduced, and user experience is enhanced.

### BRIEF DESCRIPTION OF DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic flowchart of a wireless communication method according to Embodiment 1 of the present disclosure;

FIG. 2 is a schematic flowchart of a wireless communication method according to Embodiment 2 of the present disclosure;

FIG. 3 is a schematic flowchart of a wireless communication method according to Embodiment 3 of the present disclosure;

FIG. 4 is a schematic flowchart of a wireless communication method according to Embodiment 4 of the present disclosure;

FIG. 5 is a schematic flowchart of a wireless communication method according to Embodiment 5 of the present disclosure;

FIG. 6 is a schematic flowchart of a wireless communication method according to Embodiment 6 of the present disclosure;

FIG. 7 is a schematic flowchart of a wireless communication method according to Embodiment 7 of the present disclosure;

FIG. 8 is a schematic flowchart of a wireless communication method according to Embodiment 8 of the present disclosure;

FIG. 9 is a schematic flowchart of a wireless communication method according to Embodiment 9 of the present disclosure;

FIG. 10 is a schematic diagram of a wireless terminal according to Embodiment 10 of the present disclosure;

FIG. 11 is a schematic diagram of a wireless terminal according to Embodiment 11 of the present disclosure;

FIG. 12 is a schematic diagram of a wireless terminal according to Embodiment 12 of the present disclosure;

FIG. 13 is a schematic diagram of a wireless terminal according to Embodiment 13 of the present disclosure;

FIG. 14 is a schematic diagram of a wireless terminal according to Embodiment 14 of the present disclosure;

FIG. 15 is a schematic diagram of a wireless terminal according to Embodiment 15 of the present disclosure;

FIG. 16 is a schematic flowchart of a wireless communication method according to Embodiment 16 of the present disclosure;

FIG. 17 is a schematic diagram of a wireless communications device according to Embodiment 17 of the present disclosure;

FIG. 18 is a schematic diagram of a wireless communications device according to Embodiment 18 of the present disclosure;

FIG. 19 is a schematic diagram of a wireless communications device according to Embodiment 19 of the present disclosure;

FIG. 20 is a schematic diagram of a wireless communications device according to Embodiment 20 of the present disclosure;

FIG. 21 is a schematic diagram of a wireless communications device according to Embodiment 21 of the present disclosure; and

FIG. 22 is a schematic diagram of a wireless communications device according to Embodiment 22 of the present disclosure.

### DESCRIPTION OF EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

When ordinal numbers such as “first” and “second” are mentioned in the embodiments of the present disclosure, it should be understood that they merely play a role of distinction unless they really express the meaning of a sequence according to the context.

A wireless terminal in the embodiments of the present disclosure supports at least a first radio access technology (RAT) and a second RAT. The RATs may be various radio access technologies, for example, E-UTRA (Evolved Universal Terrestrial Radio Access), UTRA (Universal Telecommunication Radio Access), GERAN (GSM EDGE Radio Access Network)-CS, GERAN-PS, or other radio access technologies, where GSM is an acronym of Global System for Mobile Communications (Global System for Mobile Communications), and EDGE is an acronym of enhanced data rate for GSM evolution technology (Enhanced Data Rate for GSM Evolution).

In the embodiments of the present disclosure, the first RAT and second RAT are different network standards. For example, the first RAT may be 2G (including 2G PS and 2G CS) or a 2G PS domain, and may also be 3G, and may also be a 2G PS domain and 3G, or 2G and 3G; the second RAT may be 4G, where the 2G may be a GERAN, the 2G PS may be GERAN-PS, the 3G may be UTRA, and the 4G may be E-UTRA. When the 4G is E-UTRA (that is, the second RAT is E-UTRA), a 4G network is an E-UTRAN (Evolved Universal Terrestrial Radio Access Network) (that is, the second RAT network is an E-UTRAN). Certainly, the first RAT and second RAT are not limited thereto.

A wireless terminal in the embodiments of the present disclosure can, for example, be a mobile phone, a tablet computer, a notebook computer, a UMPC (ultra-mobile personal computer), a netbook or a PDA (personal digital assistant).

FIG. 1 is a schematic flowchart of a wireless communication method according to Embodiment 1 of the present disclosure. As shown in FIG. 1, the method includes:

Step 101: After a wireless terminal supporting a first radio access technology (RAT) and a second RAT establishes a connection with a second RAT network, the wireless terminal receives a first message sent by the second RAT network, where the first message includes content used to query a first RAT capability of the wireless terminal.

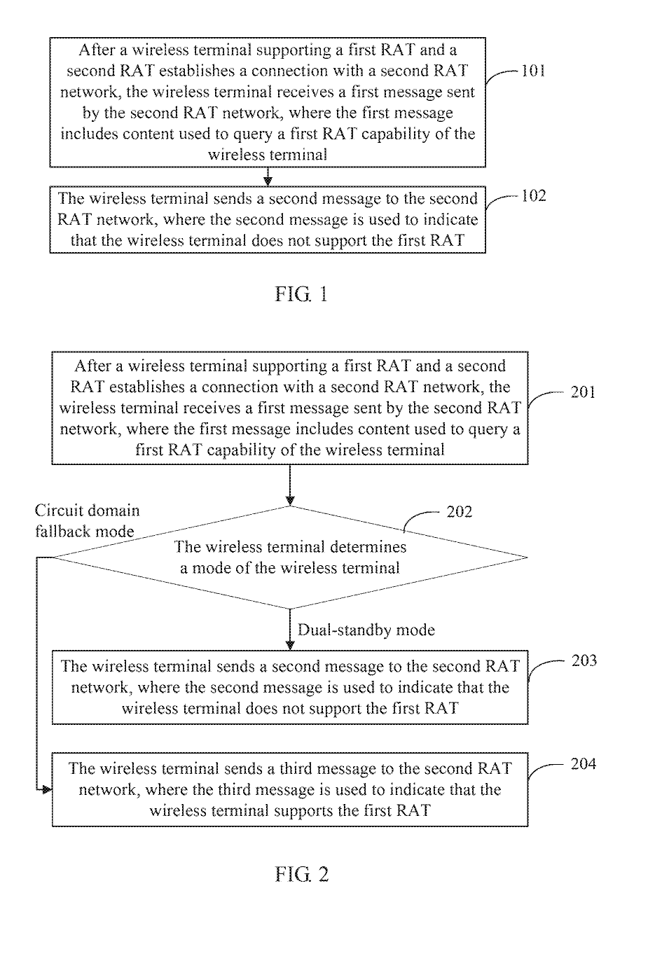

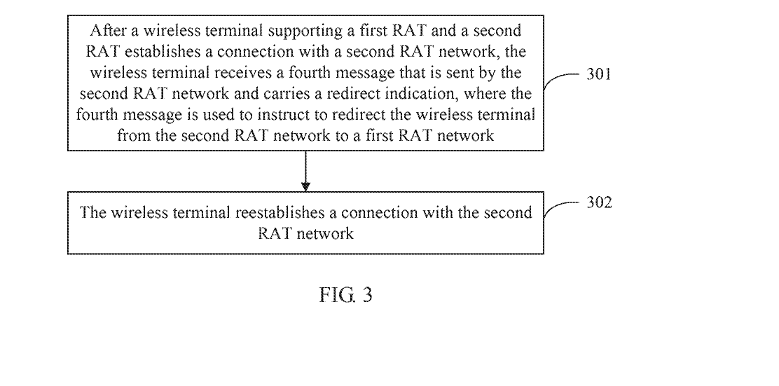

Specifically, in the embodiments shown in FIG. 1 and FIG. 2, the first RAT may be, for example, a 2G PS domain, namely, GERAN-PS.

After the wireless terminal establishes the connection with the second RAT network, the second RAT network may send the first message to the wireless terminal. When the second RAT is 4G, the connection established by the wireless terminal with the second RAT network is a radio resource control (RRC) connection, where the RRC connection is a signaling connection between the wireless terminal and an E-UTRAN (Evolved Universal Terrestrial Radio Access Network). The E-UTRAN is a base station subsystem of a 4G network, and may be specifically an eNodeB.

RRC processes layer-3 information of a control plane between the wireless terminal and the E-UTRAN. Layer 1 of the control plane between the wireless terminal and the E-UTRAN is a physical layer (Physical Layer), layer 2 is a Medium Access Control (Medium Access Control) layer, and the RRC is layer 3. The RRC allocates radio resources and sends related signaling. A main part of control signaling between the wireless terminal and the E-UTRAN is an RRC message, where the RRC message bears all parameters required for creating, modifying, and releasing layer-2 and layer-1 protocol entities, and also carries some signaling of a NAS (Non-access stratum, non-access stratum).

The first message is used to query a radio access capability of the wireless terminal. The first message in this embodiment of the present disclosure is at least used to query the first RAT capability of the wireless terminal, and may further query a second RAT capability of the wireless terminal or multiple other RAT capabilities. For example, the first message may be a capability enquiry message (UECapabilityEnquiry message) sent by the E-UTRAN to the wireless terminal, where the message may query capabilities of the radio terminal. Specifically, the message may carry E-UTRA, UTRA, GERAN-CS, and GERAN-PS, which are used to query an E-UTRA capability, a UTRA capability, a GERAN-CS capability, and a GERAN-PS capability of the UE respectively.

It should be noted that after the wireless terminal establishes the connection with the second RAT network, the second RAT network may send the first message to the wireless terminal under multiple trigger conditions. For example: 1. when the wireless terminal performs attachment (attach), that is, when the wireless terminal is powered on and accesses the second RAT network, the second RAT network may send the first message to the wireless terminal; 2. when the wireless terminal is changed from the first RAT network to the second RAT network for the first time and performs a tracking area update (Tracking Area Update, TAU), the second RAT network may send the first message to the wireless terminal; 3. when a capability of the wireless terminal changes, the wireless terminal sends a TAU message carrying a capability change of the wireless terminal to a network entity (for example, a mobility management entity, Mobility Management Entity, MME), and the network entity instructs, according to the TAU message, the second RAT network to send the first message to the wireless terminal; 4. when capability information of the wireless terminal stored in the network entity (for example, the MME) is incorrect or is deleted, the network entity may instruct the second RAT network, and then the second RAT network may send the first message to the wireless terminal. Herein a method for instructing, by the network entity, the second RAT network to send the first message to the wireless terminal, is specifically as follows: When the network entity sends an S1 initial context setup request (INITIAL CONTEXT SETUP REQUEST) message to the wireless terminal, the capability information of the wireless terminal is not included; the second RAT network learns, according to the S1 setup request message that does not include the capability information of the wireless terminal, that it is necessary to send the first message to the wireless terminal.

Step 102: The wireless terminal sends a second message to the second RAT network, where the second message is used to indicate that the wireless terminal does not support the first RAT.

The wireless terminal needs to report queried capabilities to the second RAT network after receiving the first message sent by the second RAT network. In the prior art, the wireless terminal needs to report its capabilities to the second RAT network according to facts. However, in this embodiment of the present disclosure, to avoid frequent changes of the wireless terminal between the second RAT network and the first RAT network, the wireless terminal does not report its first RAT capability when reporting capabilities to the second RAT network, that is, the wireless terminal notifies the second RAT network that the wireless terminal does not support the first RAT.

Specifically, the second message may be a capability information message (UECapabilityInformation message) sent by the wireless terminal to the second RAT network.

In the prior art, when the wireless terminal supports the first RAT, the message reported by the wireless terminal includes the first RAT capability, for example, the first RAT is GERAN-PS, and the first RAT capability in the message includes the following content:

rat-Type=GERAN-PS

Access types supported by the wireless terminal: GSM900-P, GSM 900-E, GSM 900-R, GSM 1800, GSM 1900, and so on, radio frequency power capability, multi-timeslot capability, handover capability, dual-bearer capability, frequency change capability, supported encryption algorithm, and so on.

In this embodiment of the present disclosure, although the wireless terminal supports the first RAT, the second message reported by the wireless terminal does not include the first RAT capability, for example, the first RAT is GERAN-PS, but the second message does not include the foregoing content. When the second RAT network receives the second message that does not include the first RAT capability, the second RAT network learns that the wireless terminal does not support the first RAT.

In another implementation manner, the second message may include an identifier used to indicate that the wireless terminal does not support the first RAT; when the second RAT network obtains the identifier, the second RAT network may learn that the wireless terminal does not support the first RAT.

When the first message further queries other RAT capabilities (for example, the second RAT capability) in addition to the first RAT capability, the second message sent by the wireless terminal may include other RAT capabilities supported by the wireless terminal.

In this embodiment of the present disclosure, after a wireless terminal supporting a first RAT and a second RAT establishes a connection with a second RAT network, the wireless terminal may receive a first message that is sent by the second RAT network and used to query a first RAT capability of the wireless terminal; and the wireless terminal sends a second message to the second RAT network, where the second message is used to indicate that the wireless terminal does not support the first RAT. Because the wireless terminal reports that the wireless terminal does not support the first RAT to the second RAT network, the second RAT network does not instruct to change the wireless terminal to the first RAT. Therefore, the wireless terminal may work in the second RAT for a long time, the number of changes of the wireless terminal between the first RAT and the second RAT is reduced, network load is reduced, and user experience is enhanced.

It should be noted that the change in the embodiments of the present disclosure includes a redirection and handover (handover) process of the wireless terminal in a connected state, and a cell reselection process of the wireless terminal in a non-connected state (namely, an idle state).

FIG. 2 is a schematic flowchart of a wireless communication method according to Embodiment 2 of the present disclosure. As shown in FIG. 2, the method includes:

Step 201: After a wireless terminal supporting a first RAT and a second RAT establishes a connection with a second RAT network, the wireless terminal receives a first message sent by the second RAT network, where the first message includes content used to query a first RAT capability of the wireless terminal.

This step is the same as step 101 in the embodiment shown in FIG. 1.

Step 202: The wireless terminal determines a mode of the wireless terminal; and if the wireless terminal is in a dual-standby mode, performs step 203; or if the wireless terminal is in a circuit domain fallback mode, performs step 204.

It should be noted that the wireless terminal may determine the mode of the wireless terminal after step 201, or may also determine the mode of the wireless terminal before receiving the first message. This embodiment of the present disclosure does not limit when the wireless terminal determines the mode of the wireless terminal.

The wireless terminal generally supports two modes: a dual-standby mode and a circuit domain fallback (cs fallback, CSFB) mode. Dual-standby is as follows: The wireless terminal has two radio frequency modules, which can send and receive data simultaneously in two networks, for example, the wireless terminal may simultaneously work in a 2G/3G CS network and a 4G network. Specifically, the dual-standby mode may be an SGLTE (simultaneous GSM and LTE, simultaneous GSM and LTE supported) mode, or an SVLTE (simultaneous Voice and LTE, simultaneous voice and LTE supported) mode.

Specifically, a method for determining the mode of the wireless terminal by the wireless terminal may be as follows: The wireless terminal determines whether a public land mobile network identifier (PLMN ID) of a second RAT cell on which the wireless terminal currently camps is in an operator controlled PLMN selector list (Operator Controlled PLMN (Selector List), OPLMN) stored by the wireless terminal; and if the PLMN ID is in the OPLMN, determines that the wireless terminal is in the dual-standby mode; or if the PLMN ID is not in the OPLMN, determines that the wireless terminal is in the circuit domain fallback mode.

Step 203: The wireless terminal sends a second message to the second RAT network.

The second message sent by the wireless terminal to the second RAT network in this step is the same as the second message in the embodiment shown in FIG. 1. For details, refer to the description in step 102 in the embodiment shown in FIG. 1.

Compared with the embodiment shown in FIG. 1, in this embodiment, the wireless terminal first determines the mode of the wireless terminal before sending the second message, and sends the second message only when the wireless terminal is in the dual-standby mode.

Step 204: The wireless terminal sends a third message to the second RAT network, where the third message is used to indicate that the wireless terminal supports the first RAT.

A working principle of the circuit domain fallback mode is as follows: A radio frequency of the wireless terminal works in a multi-mode single-standby mode, that is, only a master radio frequency module works, and the master radio frequency module provides a PS domain service and a CS domain service. The wireless terminal works in the 4G network when no CS domain service (for example, a voice call) is required; and falls back to the 2G/3G network when a CS domain service is required, and uses the 2G/3G CS network to implement the CS domain service. After the CS domain service ends, the wireless terminal returns to the 4G network. When the wireless terminal falls back from the 4G network to the 2G/3G network, the fallback is implemented by an E-UTRAN of the 4G network by using a redirect or change (handover) message. Therefore, if the wireless terminal is in the circuit domain fallback mode, the second RAT network needs to correctly learn capabilities of the wireless terminal, and thereby may redirect or change the wireless terminal from the 4G network to the 2G/3G network when a user requests the CS domain service, and implement the CS domain service. Otherwise, if the network cannot correctly learn the capabilities of the wireless terminal, the wireless terminal cannot be redirected or changed to the 2G/3G network, and the CS domain service cannot be completed. Therefore, in this case, the wireless terminal needs to report the capabilities to the second RAT network according to facts. When the wireless terminal supports the first RAT, the third message sent by the wireless terminal to the second RAT network includes the first RAT capability. For example, the first RAT is GERAN-PS, and the third message includes the first RAT capability, that is, includes the following content:

rat-Type=GERAN-PS

Access types supported by the wireless terminal: GSM900-P, GSM 900-E, GSM 900-R, GSM 1800, GSM 1900, and so on, radio frequency power capability, multi-timeslot capability, handover capability, dual-bearer capability, frequency change capability, supported encryption algorithm, and so on.

It should be noted that this embodiment of the present disclosure may further include the following step: After the wireless terminal establishes the connection with the second RAT network, the wireless terminal does not detect a signal strength corresponding to the first RAT.

After the wireless terminal reports capability information to the second RAT network, the second RAT network may subsequently request the wireless terminal to report a signal strength corresponding to a network supported by the wireless terminal. For example, if the wireless terminal reports that the wireless terminal supports the second RAT to the second RAT network, the second RAT network may request the wireless terminal to report a signal strength that is detected by the wireless terminal and corresponding to the second RAT. Because the wireless terminal reports that the wireless terminal does not support the first RAT to the second RAT network, subsequently when the second RAT network requests the wireless terminal to report signal strengths of other RATs except the second RAT, the wireless terminal may not report the signal strength of the first RAT. Therefore, to reduce power consumption, the wireless terminal may not detect the signal strength corresponding to the first RAT.

In another implementation manner, the wireless terminal may no longer detect, after determining that the wireless terminal is in the dual-standby mode, the signal strength corresponding to the first RAT.

Compared with the embodiment shown in FIG. 1, in this embodiment of the present disclosure, a wireless terminal sends, only when determining that the wireless terminal is in a dual-standby mode, a second message to a second RAT network, where the second message is used to indicate that the wireless terminal does not support a first RAT. Because the wireless terminal reports that the wireless terminal does not support the first RAT to the second RAT network, the second RAT network does not instruct to change the wireless terminal to the first RAT. Therefore, the wireless terminal may work in the second RAT for a long time, the number of changes of the wireless terminal between the first RAT and the second RAT is reduced, network load is reduced, and user experience is enhanced.

FIG. 3 is a schematic flowchart of a wireless communication method according to Embodiment 3 of the present disclosure. As shown in FIG. 3, the method includes:

Step 301: After a wireless terminal supporting a first RAT and a second RAT establishes a connection with a second RAT network, the wireless terminal receives a fourth message that is sent by the second RAT network and carries a redirect (redirect) indication, where the fourth message is used to instruct to redirect the wireless terminal from the second RAT network to a first RAT network.

It should be noted that in the embodiments shown in FIG. 3 to FIG. 9, the first RAT may be, for example, 2G, namely, a GERAN.

After the wireless terminal establishes the connection with the second RAT network, the wireless terminal and the second RAT network may perform wireless communication. After the wireless terminal establishes the connection with the second RAT network, when the second RAT network queries capabilities of the wireless terminal, the wireless terminal may report that the wireless terminal supports the first RAT and the second RAT to the second RAT network. In a process of performing wireless communication by the wireless terminal with the second RAT network, the second RAT network may request the wireless terminal to report a measurement report of each network, where the measurement report may include a signal strength of each network that is detected by the wireless terminal, for example, a signal strength of the first RAT and a signal strength of the second RAT. When the second RAT network learns, according to the measurement report reported by the wireless terminal, that the signal strength of the second RAT is poor, the second RAT network may instruct to redirect the wireless terminal to the first RAT network.

When the second RAT network instructs to redirect the wireless terminal to the first RAT network, the wireless terminal receives the fourth message that is sent by the second RAT network and carries the redirect indication. When the second RAT is E-UTRA, the fourth message may be an RRC connection release message (RRCConnectionRelease) carrying a redirect indication.

Step 302: The wireless terminal reestablishes a connection with the second RAT network.

In the prior art, after receiving the fourth message, the wireless terminal needs to make a reselection (reselect) to the first RAT according to the fourth message, and establishes a connection with the first RAT network.

However, in this embodiment of the present disclosure, to avoid frequent changes of the wireless terminal between the second RAT and the first RAT, the wireless terminal is not redirected to the first RAT network after receiving the fourth message, but selects to continue to camp on the second RAT. That is, in this embodiment, the wireless terminal reestablishes the connection with the second RAT network after receiving the fourth message, where the message may be, for example, an RRC connection.

In this embodiment of the present disclosure, after a wireless terminal supporting a first RAT and a second RAT establishes a connection with a second RAT network, when the wireless terminal receives a fourth message that is sent by the second RAT network and used to instruct to redirect the wireless terminal to a first RAT network, the wireless terminal does not perform a redirection to the first RAT network, but reestablishes a connection with the second RAT network and continues to camp on the second RAT. Therefore, the wireless terminal may work in the second RAT for a long time, the number of changes of the wireless terminal between the first RAT and the second RAT is reduced, network load is reduced, and user experience is enhanced.

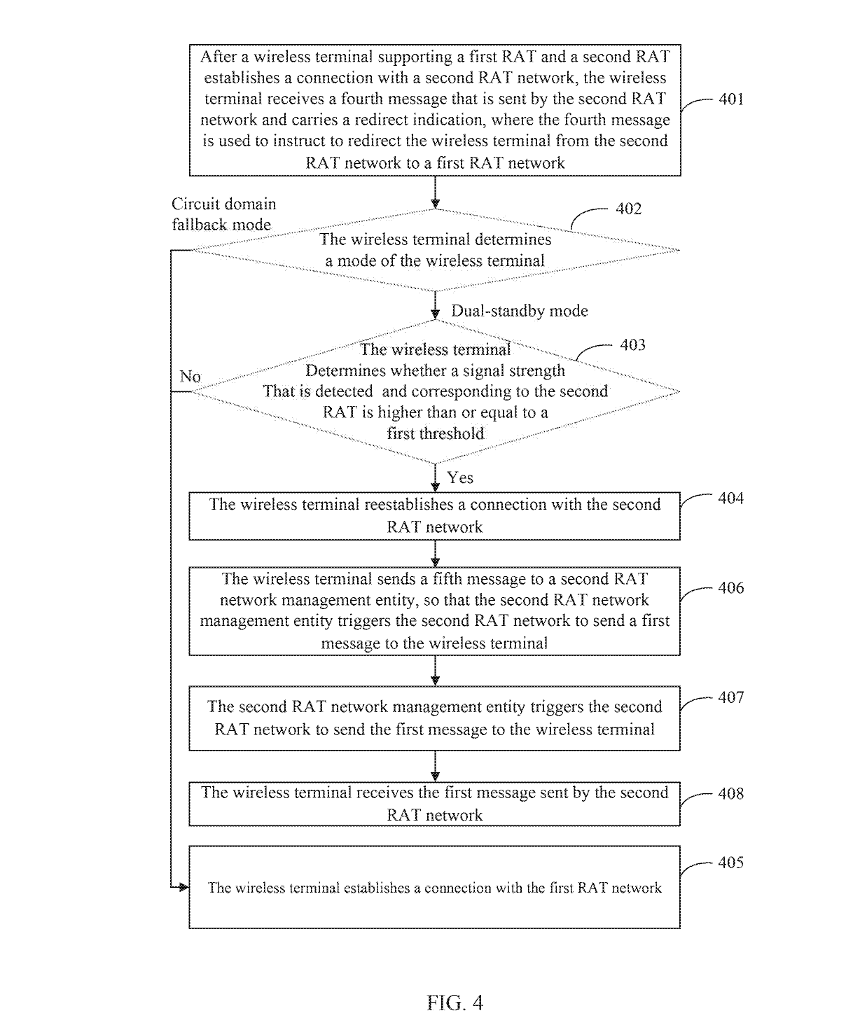

FIG. 4 is a schematic flowchart of a wireless communication method according to Embodiment 4 of the present disclosure. As shown in FIG. 4, the method includes:

Step 401: After a wireless terminal supporting a first RAT and a second RAT establishes a connection with a second RAT network, the wireless terminal receives a fourth message that is sent by the second RAT network and carries a redirect indication, where the fourth message is used to instruct to redirect the wireless terminal from the second RAT network to a first RAT network.

This step is the same as step 301 in the embodiment shown in FIG. 3.

Step 402: The wireless terminal determines a mode of the wireless terminal; and if the wireless terminal is in a dual-standby mode, performs step 403; or if the wireless terminal is in a circuit domain fallback mode, performs step 405.

For a specific process of determining the mode of the wireless terminal by the wireless terminal, refer to the description in step 202 of the embodiment shown in FIG. 2.

Step 403: The wireless terminal determines whether a signal strength that is detected by the wireless terminal and corresponding to the second RAT is higher than or equal to a first threshold; and when the signal strength that is detected by the wireless terminal and corresponding to the second RAT is higher than or equal to the first threshold, performs step 404; or otherwise, performs step 405.

After the wireless terminal receives the fourth message and determines that the wireless terminal is in the dual-standby mode, the wireless terminal may determine whether the current signal strength corresponding to the second RAT is poor. When the signal strength corresponding to the second RAT is higher than or equal to the first threshold, it indicates that the current signal strength corresponding to the second RAT is not poor. In this case, the wireless terminal may select to continue to camp on the second RAT network, instead of being redirected to the first RAT network; when the signal strength corresponding to the second RAT is lower than the first threshold, it indicates that the current signal strength corresponding to the second RAT is poor. In this case, the wireless terminal may select to be redirected to the first RAT network. The first threshold may be a preset fixed value, or may also be adjusted dynamically according to an actual condition.

It should be noted that in another implementation manner, step 403 may also be omitted; when it is determined that the wireless terminal is in the dual-standby mode in step 402, step 404 is directly performed.

Step 404: The wireless terminal reestablishes a connection with the second RAT network.

After the wireless terminal reestablishes the connection with the second RAT network, the wireless terminal camps on the second RAT network.

Step 405: The wireless terminal establishes a connection with the first RAT network.

When the wireless terminal is in the circuit domain fallback mode, or when the signal strength of the second RAT network is very poor, the wireless terminal makes a reselection to the first RAT network according to the fourth message, and initiates a location update request, thereby completing a process of redirecting wireless terminal to the first RAT network.

Further, in other implementation manners, after step 404, this embodiment may further include the following steps:

Step 406: The wireless terminal sends a fifth message to a second RAT network management entity, so that the second RAT network management entity triggers the second RAT network to send a first message to the wireless terminal.

After the wireless terminal reestablishes the connection with the second RAT network, the wireless terminal may send the fifth message to the second RAT network management entity. The second RAT network management entity may be, for example, a mobility management entity (MME). The fifth message is used to notify the MME that a capability of the wireless terminal changes, for example, the fifth message may be specifically a TAU (tracking area update, tracking area update) message carrying “UE radio capability information update needed=1”.

Step 407: The second RAT network management entity triggers the second RAT network to send the first message to the wireless terminal.

The MME sends a notification message to the second RAT network after receiving the fifth message, where the notification message is used to notify the second RAT network that the capability of the wireless terminal changes; then the second RAT network sends the first message to the wireless terminal, where the first message is used to query capabilities of the wireless terminal. For example, the MME triggers, by using an INITIAL CONTEXT SETUP (initial context setup) message that carries no UE Radio Capability information (wireless terminal radio capability information), the second RAT network to send the first message to the wireless terminal.

Step 408: The wireless terminal receives the first message sent by the second RAT network.

For the first message, refer to the description in step 101 of the embodiment shown in FIG. 1.

After step 408, this embodiment may further include step 102 in the embodiment shown in FIG. 1. Alternatively, after step 408, this embodiment may further include step 202 to step 204 in the embodiment shown in FIG. 2.

That is, the wireless terminal may send a second message to the second RAT network, where the second message is used to indicate that the wireless terminal does not support the first RAT, so that the second RAT network does not send the fourth message used for the redirection, to the wireless terminal any longer.

Compared with the embodiment shown in FIG. 3, in this embodiment of the present disclosure, after a wireless terminal establishes a connection with a second RAT network, when the wireless terminal receives a fourth message that is sent by the second RAT network and used to instruct to redirect the wireless terminal to a first RAT network, the wireless terminal does not perform a redirection to the first RAT network when determining that a signal strength of the second RAT network is higher than or equal to a preset value, but reestablishes a connection with the second RAT network and continues to camp on the second RAT network. In addition, after the wireless terminal reestablishes the connection with the second RAT network, the wireless terminal may trigger, by using a second RAT network management entity, the second RAT network to deliver a first message; when making a reply according to the first message, the wireless terminal may send a second message to the second RAT network, where the second message is used to indicate that the wireless terminal does not support the first RAT, so that the second RAT network does not send a message used for a redirection, to the wireless terminal any longer. Therefore, the wireless terminal may work in the second RAT for a long time, the number of changes of the wireless terminal between the first RAT and the second RAT is reduced, network load is reduced, and user experience is enhanced.

Another embodiment of the present disclosure further provides a wireless communication method, where the method may include:

Step 1: After a wireless terminal supporting a first RAT and a second RAT establishes a connection with a second RAT network, the wireless terminal receives a fourth message that is sent by the second RAT network and carries a redirect indication.

This step is the same as step 301 in the embodiment shown in FIG. 3.

Step 2: The wireless terminal performs an operation of making a reselection to the first RAT; after a NAS (non-access stratum) layer of the wireless terminal receives an indication that the wireless terminal camps on the first RAT network, the NAS layer instructs the wireless terminal to make a reselection to the second RAT network, instead of initiating a routing area update (RAU) request in the first RAT network.

In a protocol stack, RRC and protocol layers below the RRC are referred to as an access stratum (AS) layer, and protocol layers above them are referred to as a non-access stratum. Procedures of the access stratum mainly include PLMN selection, cell selection, and radio resource management procedures. From the layers of the protocol stack, all the procedures of the access stratum are some lower-layer procedures, which are used to set up lower-layer bearers for upper-layer signaling procedures. Procedures of the non-access stratum mainly include mobility management and session management. In a mobility management aspect, the non-access stratum is mainly responsible for PLMN selection, RAT selection, registration with a RAT network management entity (for example, an MME), and update of latest location information of the wireless terminal. In PLMN selection and RAT selection aspects, the NAS layer may instruct the AS layer to select a specific PLMN or RAT for camping.

In the prior art, the AS layer of the wireless terminal may report to the NAS layer after making a reselection to the first RAT, so that the NAS layer performs a mobility management function, that is, sends a routing area update message to the RAT network management entity (for example, an SGSN: Serving GPRS SUPPORT NODE, serving GPRS support node) in the first RAT, so that the SGSN learns location information of the wireless terminal.

In this embodiment, the NAS layer of the wireless terminal does not send a routing area update message in the first RAT after receiving an indication of camping on the first RAT network from the AS layer, but instructs the AS layer to select the second RAT network for camping.

Further, before the NAS layer of the wireless terminal instructs the wireless terminal to make a reselection to the second RAT network in step 2, the wireless terminal may first determine a working mode of the wireless terminal; and if the wireless terminal works in a dual-standby mode, the NAS layer of the wireless terminal instructs the wireless terminal to make a reselection to the second RAT network.

FIG. 5 is a schematic flowchart of a wireless communication method according to Embodiment 5 of the present disclosure. As shown in FIG. 5, the method includes:

Step 501: After a wireless terminal supporting a first RAT and a second RAT establishes a connection with a second RAT network, the wireless terminal receives a measurement configuration sent by the second RAT network, where the measurement configuration is used to configure the wireless terminal to send a measurement report to the second RAT network under a preset condition.

When the second RAT is E-UTRA, the connection established by the wireless terminal with the second RAT network may be an RRC connection.

After the wireless terminal establishes the connection with the second RAT network, the second RAT network may query capabilities of the wireless terminal. When the wireless terminal receives a message that is sent by the second RAT network and used to query capabilities, the wireless terminal may report that the wireless terminal supports the first RAT and the second RAT to the second RAT network. Then, the second RAT network may send the measurement configuration to the wireless terminal. Specifically, the second RAT network may perform a measurement configuration for the wireless terminal by using an RRC connection reconfiguration (RRC ConnectionReconfiguration) message.

The measurement configuration is used to configure the wireless terminal to send a measurement report to the second RAT network under the preset condition, where the measurement report may include: a signal strength corresponding to the first RAT and/or a signal strength corresponding to the second RAT network. The signal strength may include received power (Received Power) and/or received quality (Received Quality).

There may be multiple preset conditions, for example: 1. when the signal strength corresponding to the second RAT is lower than a threshold; 2. when a signal strength corresponding to a neighboring cell of a cell in which the wireless terminal is located is higher than or equal to a threshold; 3. when the signal strength corresponding to the first RAT is higher than a threshold; 4. when the signal strength corresponding to the first RAT minus the signal strength corresponding to the second RAT is higher than or equal to a threshold.

Step 502: The wireless terminal sends a measurement report including processed signal strengths to the second RAT network when the preset condition is met.

When the configured preset condition is met, the wireless terminal needs to send a measurement report to the second RAT network. In this embodiment, the wireless terminal generates a measurement report after processing a signal strength that is detected and corresponding to the first RAT or a signal strength that is detected and corresponding to the second RAT, and then sends the measurement report to the second RAT network.

The measurement report sent by the wireless terminal may include: a processed first signal strength corresponding to the first RAT and/or a processed second signal strength corresponding to the second RAT. The first signal strength is lower than the signal strength that is detected by the wireless terminal and corresponding to the first RAT, and the second signal strength is higher than the signal strength that is detected by the wireless terminal and corresponding to the second RAT.

Specifically, the first signal strength may be obtained in the following manner: obtaining the first signal strength by subtracting a first preset value from the signal strength that is detected by the wireless terminal and corresponding to the first RAT, or obtaining the first signal strength by subtracting a first preset amplitude from the signal strength that is detected by the wireless terminal and corresponding to the first RAT, or directly using a fourth threshold as the first signal strength, where the fourth threshold is lower than the signal strength that is detected by the wireless terminal and corresponding to the first RAT. That is, when the wireless terminal reports the signal strength corresponding to the first RAT, the reported signal strength value is less than an actual signal strength value. The preset value, first preset amplitude, and fourth threshold may be preconfigured, for example, they are preconfigured in the wireless terminal before a delivery of the wireless terminal, or configured in the wireless terminal by a manufacturer/operator by using an over-the-air (Over-the-Air, OTA) technology; or the first preset value, first preset amplitude, and fourth threshold may also be obtained by the wireless terminal by dynamically learning according to network conditions, for example, the wireless terminal makes attempts continuously until the number of redirections of the wireless terminal is minimum. For example, if the signal strength that is detected and corresponding to the first RAT is −90 dBm, the first signal strength may be −90 dBm minus a preset value, for example, −90−10=−100 dBm; or the first signal strength may be −90 dBm minus a preset amplitude, for example, −90×(1+15%)=−103.5 dBm, or the first signal strength may be fixed at −105 dBm. It should be noted that because the signal strength is a negative number, an absolute value of a specific numeric value is larger after the signal strength minus a preset value or preset amplitude.

The second signal strength may be obtained in the following manner: obtaining the second signal strength by adding a second preset value to the signal strength that is detected by the wireless terminal and corresponding to the second RAT, or obtaining the second signal strength by adding a second preset amplitude to the signal strength that is detected by the wireless terminal and corresponding to the second RAT, or directly using a fifth threshold as the second signal strength, where the fifth threshold is higher than the signal strength that is detected by the wireless terminal and corresponding to the second RAT. That is, when the wireless terminal reports the signal strength corresponding to the second RAT, the reported signal strength value is greater than an actual signal strength value.

When the second RAT network learns that a signal corresponding to the second RAT is weak or that a signal corresponding to the first RAT is strong, the second RAT network may instruct to redirect the wireless terminal from the second RAT network to a first RAT network. In this embodiment, because the signal strength that is reported by the wireless terminal and corresponding to the first RAT is lower than the actual signal strength, or the signal strength that is reported by the wireless terminal and corresponding to the second RAT is higher than the actual signal strength, the second RAT network may delay sending a redirect indication to the wireless terminal, and therefore the number of changes of the wireless terminal between the second RAT and the first RAT may be reduced.

In this embodiment of the present disclosure, after a wireless terminal supporting a first RAT and a second RAT establishes a connection with a second RAT network, when the wireless terminal receives a measurement configuration sent by the second RAT network, the wireless terminal processes a signal strength corresponding to the first RAT or a signal strength corresponding to the second RAT, and then reports the processed signal strengths to the second RAT network. Because the signal strength that is reported by the wireless terminal and corresponding to the first RAT is lower than an actual signal strength, or the signal strength that is reported by the wireless terminal and corresponding to the second RAT is higher than an actual signal strength, the number of changes of the wireless terminal between the first RAT and the second RAT may be reduced, the wireless terminal may work in the second RAT for a long time, network load is reduced, and user experience is enhanced.

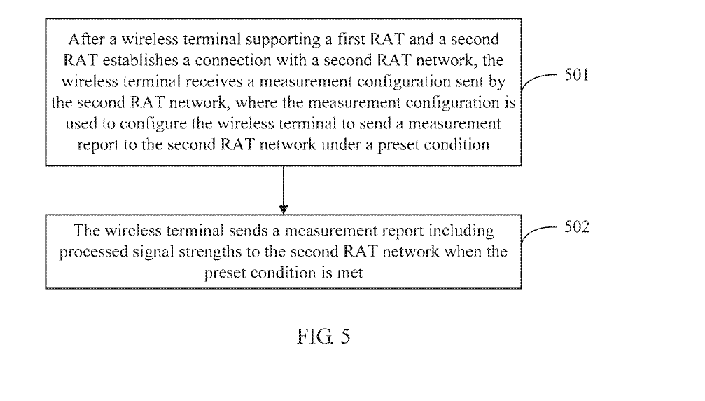

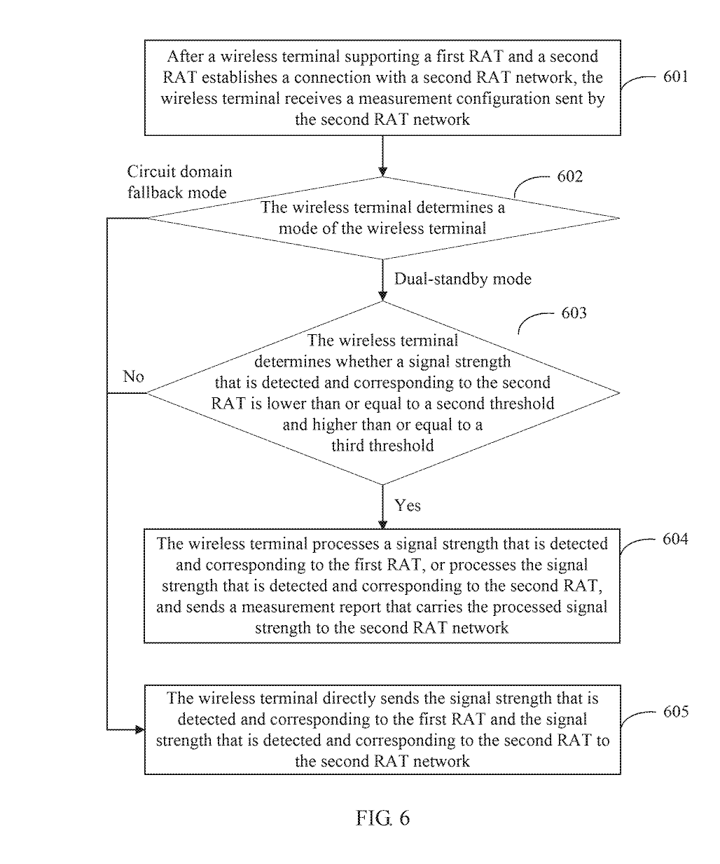

FIG. 6 is a schematic flowchart of a wireless communication method according to Embodiment 6 of the present disclosure. On a basis of the embodiment shown in FIG. 5, as shown in FIG. 6, the method includes:

Step 601: After a wireless terminal supporting a first RAT and a second RAT establishes a connection with a second RAT network, the wireless terminal receives a measurement configuration sent by the second RAT network.

This step is the same as step 501 in the embodiment shown in FIG. 5.

Step 602: The wireless terminal determines a mode of the wireless terminal; and if the wireless terminal is in a dual-standby mode, performs step 603; or if the wireless terminal is in a circuit domain fallback mode, performs step 605.

For a specific process of determining the mode of the wireless terminal by the wireless terminal, refer to the description in step 202 of the embodiment shown in FIG. 2.

Step 603: The wireless terminal determines whether a signal strength that is detected by the wireless terminal and corresponding to the second RAT is lower than or equal to a second threshold and higher than or equal to a third threshold; and when the signal strength corresponding to the second RAT is lower than or equal to the second threshold and higher than or equal to the third threshold, performs step 604; or otherwise, performs step 605.

Before the wireless terminal processes a signal strength that is detected and corresponding to the first RAT or the signal strength that is detected and corresponding to the second RAT, the wireless terminal may first determine a signal strength value that is detected and corresponding to the second RAT. When the signal strength that is detected and corresponding to the second RAT is high enough (for example, higher than the second threshold), it indicates that a signal corresponding to the second RAT is good; in this case, the second RAT network does not instruct to redirect the wireless terminal, and therefore the detected signal strength does not need to be processed, but instead, the detected signal strength is directly sent to the second RAT network. When the signal strength that is detected and corresponding to the second RAT is low (for example, lower than the third threshold), it indicates that a signal corresponding to the second RAT is weak; in this case, the wireless terminal possibly cannot work in the second RAT network, and therefore the detected signal strength does not need to be processed, but instead, the detected signal strength is directly sent to the second RAT network, so that the second RAT network triggers the wireless terminal to make a redirection to the first RAT network.

Therefore, only when the signal strength that is detected and corresponding to the second RAT is lower than or equal to the second threshold and higher than or equal to the third threshold, the wireless terminal may process the detected signal strength and send the processed signal strength to the second RAT network. The second threshold is higher than the third threshold.

It should be noted that in another implementation manner, step 603 may also be omitted; when it is determined that the wireless terminal is in the dual-standby mode in step 602, step 604 is directly performed. Alternatively, in another implementation manner, step 602 may be omitted, and after step 601, step 603 is directly performed.

Step 604: The wireless terminal processes a signal strength that is detected and corresponding to the first RAT, or processes the signal strength that is detected and corresponding to the second RAT, and sends a measurement report that carries the processed signal strength to the second RAT network.

In another implementation manner, the wireless terminal may process both the signal strength that is detected and corresponding to the first RAT and the signal strength that is detected and corresponding to the second RAT, and then send a measurement that carries the processed signal strengths to the second RAT network.

The wireless terminal obtains, by decreasing the signal strength that is detected and corresponding to the first RAT, the first signal strength corresponding to the first RAT; the wireless terminal obtains, by increasing the signal strength that is detected and corresponding to the second RAT, the second signal strength corresponding to the second RAT. For specific methods for obtaining the first signal strength and the second signal strength, refer to the description in step 502 in the embodiment shown in FIG. 5.

Step 605: The wireless terminal directly sends the signal strength that is detected and corresponding to the first RAT and the signal strength that is detected and corresponding to the second RAT to the second RAT network.

When the wireless terminal determines that it is unnecessary to process the detected signal strengths, the wireless terminal directly sends a measurement report that carries the detected signal strengths to the second RAT network.

Compared with the embodiment shown in FIG. 5, in this embodiment of the present disclosure, a wireless terminal sends a measurement report including processed signal strengths to a second RAT network only after determining that the wireless terminal is in a dual-standby mode, or sends a measurement report including processed signal strengths to a second RAT network only after determining that a signal strength corresponding to a second RAT meets a condition. Because the signal strength that is reported by the wireless terminal and corresponding to the first RAT is lower than an actual signal strength, or the signal strength that is reported by the wireless terminal and corresponding to the second RAT is higher than an actual signal strength, the number of changes of the wireless terminal between the first RAT and the second RAT may be reduced, the wireless terminal may work in the second RAT for a long time, network load is reduced, and user experience is enhanced.

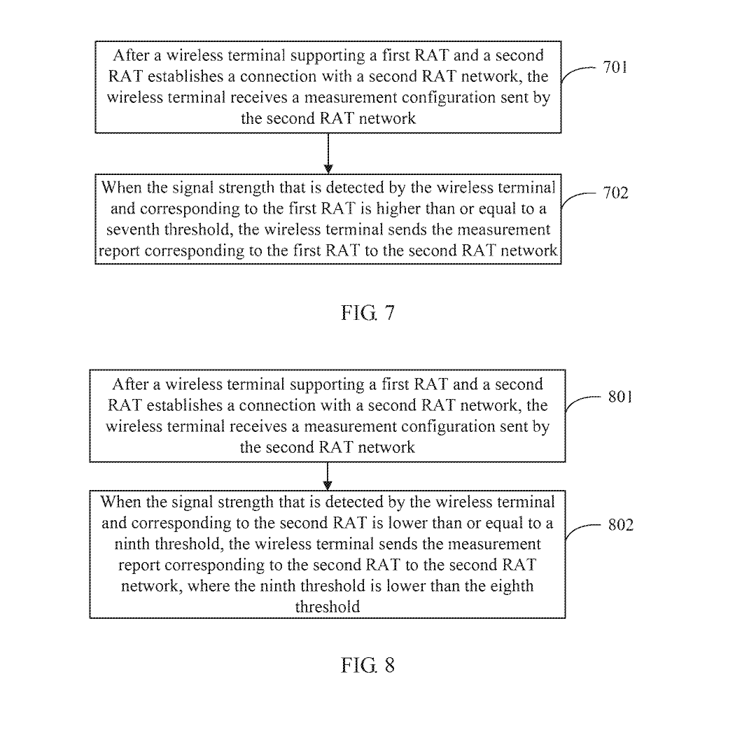

FIG. 7 is a schematic flowchart of a wireless communication method according to Embodiment 7 of the present disclosure. As shown in FIG. 7, the method includes:

Step 701: After a wireless terminal supporting a first RAT and a second RAT establishes a connection with a second RAT network, the wireless terminal receives a measurement configuration sent by the second RAT network.

The measurement configuration is used to configure the wireless terminal to send a measurement report to the second RAT network under a preset condition. In this embodiment, the preset condition may be: when a signal strength that is detected by the wireless terminal and corresponding to the first RAT is higher than or equal to a sixth threshold, the wireless terminal sends a measurement report corresponding to the first RAT. For example, if the first RAT is 2G, and the second RAT is 4G, priorities of 2G and 4G may be preconfigured; when a priority of 2G is configured to be high and a signal strength of 2G is high, a network side may allow the wireless terminal to make a reselection from 4G to 2G.

Step 702: When the signal strength that is detected by the wireless terminal and corresponding to the first RAT is higher than or equal to a seventh threshold, the wireless terminal sends the measurement report corresponding to the first RAT to the second RAT network, where the seventh threshold is higher than the sixth threshold.

In this embodiment, when the wireless terminal sends the measurement report corresponding to the first RAT to the second RAT network, the sending is triggered not by the preset condition in the measurement configuration, but by increasing the sixth threshold to the seventh threshold; the wireless terminal sends the measurement report corresponding to the first RAT to the second RAT network only when the signal strength that is detected and corresponding to the first RAT is higher than or equal to the seventh threshold. Therefore, the second RAT may delay sending a message used for a redirection, to the wireless terminal, where the message used for the redirection is used to instruct the wireless terminal to make a reselection from the second RAT to the first RAT.

It should be noted that the second RAT network may also request a measurement report corresponding to the second RAT, from the wireless terminal, so that the wireless terminal sends, under the preset condition, the measurement report corresponding to the second RAT. The wireless terminal may send, under the preset condition according to a requirement of the second RAT network, the measurement report corresponding to the second RAT.

The seventh threshold may be a preset fixed value; or the seventh threshold may be the sixth threshold plus a third preset value; or the seventh threshold is the sixth threshold plus a third preset amplitude. For example, when the sixth threshold is −90 dBm, the seventh threshold may be fixed −80 dBm, or the seventh threshold may be the sixth threshold plus a preset value, namely, −90 dBm+15 dBm, or the seventh threshold may be the sixth threshold plus a preset amplitude −90×(1-15%) dBm. It should be noted that because the sixth threshold is a negative number, an absolute value of a specific numeric value is smaller after a preset value or preset amplitude is added to the sixth threshold.

The connection established by the wireless terminal with the second RAT network may be an RRC connection.

Further, before step 702 is performed, the wireless terminal may further first determine a mode of the wireless terminal; the wireless terminal performs step 702 only when the wireless terminal is in a dual-standby mode; when the wireless terminal is in a circuit domain fallback mode, the wireless terminal sends, according to the preset condition configured for the second RAT network, the measurement report corresponding to the first RAT to the second RAT network.

In this embodiment of the present disclosure, after a wireless terminal supporting a first RAT and a second RAT establishes a connection with a second RAT network, when the wireless terminal receives a measurement configuration sent by the second RAT network, the wireless terminal does not report, according to a preset condition in the measurement configuration, a measurement report corresponding to the first RAT, but reports, only after the revised preset condition is met, the measurement report corresponding to the first RAT. Therefore, the second RAT may delay sending a message used for a redirection, to the wireless terminal. Therefore, the wireless terminal may work in the second RAT for a long time, network load is reduced, and user experience is enhanced.

FIG. 8 is a schematic flowchart of a wireless communication method according to Embodiment 8 of the present disclosure. As shown in FIG. 8, the method includes:

Step 801: After a wireless terminal supporting a first RAT and a second RAT establishes a connection with a second RAT network, the wireless terminal receives a measurement configuration sent by the second RAT network.

The measurement configuration is used to configure the wireless terminal to send a measurement report to the second RAT network under a preset condition. In this embodiment, the preset condition may be: when a signal strength that is detected by the wireless terminal and corresponding to the second RAT is lower than or equal to an eighth threshold, the wireless terminal sends a measurement report corresponding to the second RAT. For example, when the signal strength corresponding to the second RAT is poor, the second RAT network may instruct the wireless terminal to make a reselection to a first RAT network.

Step 802: When the signal strength that is detected by the wireless terminal and corresponding to the second RAT is lower than or equal to a ninth threshold, the wireless terminal sends the measurement report corresponding to the second RAT to the second RAT network, where the ninth threshold is lower than the eighth threshold.

In this embodiment, when the wireless terminal sends the measurement report corresponding to the second RAT to the second RAT network, the sending is triggered not by the preset condition in the measurement configuration, but by decreasing the eighth threshold to the ninth threshold; the wireless terminal sends the measurement report corresponding to the second RAT to the second RAT network only when the signal strength that is detected and corresponding to the first RAT is lower than or equal to the ninth threshold. Therefore, the second RAT may delay sending a message used for a redirection, to the wireless terminal, where the message used for the redirection is used to instruct the wireless terminal to make a reselection from the second RAT network to the first RAT network.

It should be noted that the second RAT network may also request a measurement report corresponding to the first RAT, from the wireless terminal, so that the wireless terminal sends, under the preset condition, the measurement report corresponding to the first RAT. The wireless terminal may send, under the preset condition according to a requirement of the second RAT network, the measurement report corresponding to the first RAT.

The ninth threshold is a preset fixed value; or the ninth threshold is the eighth threshold minus a fourth preset value; or the ninth threshold is the eighth threshold minus a fourth preset amplitude.

The connection established by the wireless terminal with the second RAT network may be an RRC connection.

Further, before step 802 is performed, the wireless terminal may further first determine a mode of the wireless terminal; the wireless terminal performs step 802 only when the wireless terminal is in a dual-standby mode; when the wireless terminal is in a circuit domain fallback mode, the wireless terminal sends, according to the preset condition configured by the second RAT network, the measurement report corresponding to the second RAT to the second RAT network.

In this embodiment of the present disclosure, after a wireless terminal supporting a first RAT and a second RAT establishes a connection with a second RAT network, when the wireless terminal receives a measurement configuration sent by the second RAT network, the wireless terminal does not report, according to a preset condition in the measurement configuration, a measurement report corresponding to the second RAT, but reports, only after the revised preset condition is met, the measurement report corresponding to the second RAT. Therefore, the second RAT may delay sending a message used for a redirection, to the wireless terminal. Therefore, the wireless terminal may work in the second RAT for a long time, network load is reduced, and user experience is enhanced.

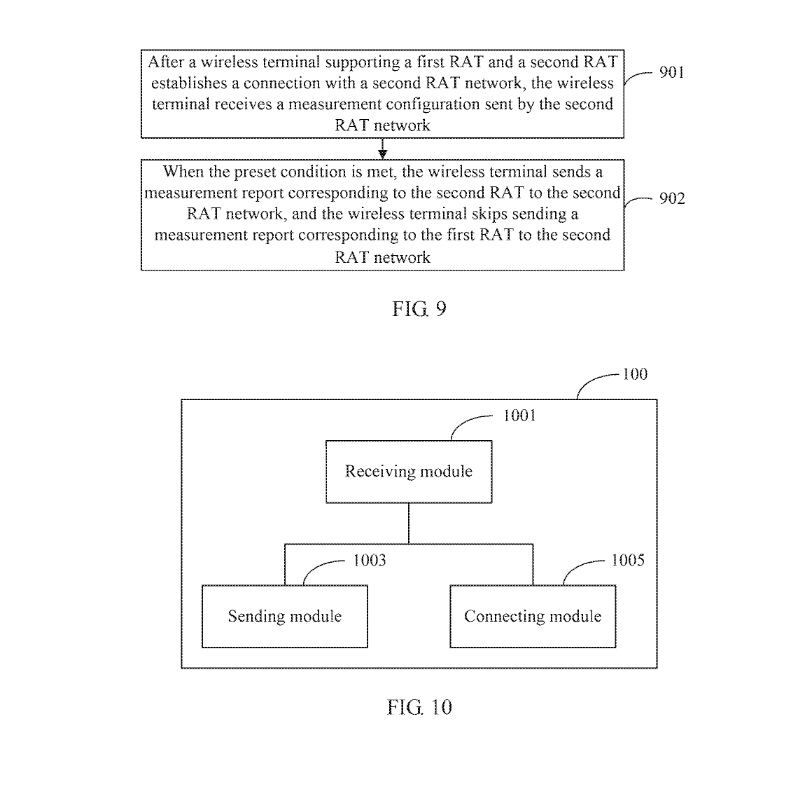

FIG. 9 is a schematic flowchart of a wireless communication method according to Embodiment 9 of the present disclosure. As shown in FIG. 9, the method includes:

Step 901: After a wireless terminal supporting a first RAT and a second RAT establishes a connection with a second RAT network, the wireless terminal receives a measurement configuration sent by the second RAT network.

The measurement configuration is used to configure the wireless terminal to send a measurement report to the second RAT network under a preset condition, where the measurement report may include signal strengths that are detected by the wireless terminal and respectively corresponding to the first RAT and second RAT.

The connection established by the wireless terminal with the second RAT network may be an RRC connection.

Step 902: When the preset condition is met, the wireless terminal sends a measurement report corresponding to the second RAT to the second RAT network, and the wireless terminal skips sending a measurement report corresponding to the first RAT to the second RAT network.

In this embodiment, when the second RAT network requests the measurement report corresponding to the first RAT, from the wireless terminal, the wireless terminal skips sending the measurement report that is detected by the wireless terminal and corresponding to the first RAT, to the second RAT network. Therefore, the second RAT network cannot learn the signal strength corresponding to the first RAT, which may reduce the number of times of instructing, by the second RAT network, the wireless terminal to make a reselection to the first RAT network.

Further, before the wireless terminal skips sending the measurement report corresponding to the first RAT to the second RAT network in step 902, the wireless terminal may further first determine a mode of the wireless terminal; the wireless terminal skips sending the measurement report corresponding to the first RAT to the second RAT network only when the wireless terminal is in a dual-standby mode; the wireless terminal sends the measurement report corresponding to the first RAT to the second RAT network when the wireless terminal is in a circuit domain fallback mode.

In this embodiment of the present disclosure, after a wireless terminal supporting a first RAT and a second RAT establishes a connection with a second RAT network, when the wireless terminal receives a measurement configuration sent by the second RAT network, the wireless terminal reports only a measurement report corresponding to the second RAT to the second RAT network, but does not report a measurement report corresponding to the first RAT to the second RAT network. Therefore, the number of changes of the wireless terminal between the first RAT and the second RAT may be reduced, the wireless terminal may work in the second RAT for a long time, network load is reduced, and user experience is enhanced.

It should be noted that all the embodiments shown in FIG. 5 to FIG. 9 may be combined with the embodiment shown in FIG. 4. Specifically, another implementation manner of the embodiment of the present disclosure may include the following content:

Step a: Step 401 to step 408 in the embodiment shown in FIG. 4 are performed, and then step b is performed.

Step b: The wireless terminal reports that the wireless terminal supports the first RAT and second RAT to the second RAT network, and then step c is performed.

Step c: Steps 501 and 502 in the embodiment shown in FIG. 5 are performed; or steps 601 to 605 in the embodiment shown in FIG. 6 are performed; or steps 701 and 702 in the embodiment shown in FIG. 7 are performed; or steps 801 and 802 in the embodiment shown in FIG. 8 are performed; or steps 901 and 902 in the embodiment shown in FIG. 9 are performed.

FIG. 10 is a schematic diagram of a wireless terminal according to Embodiment 10 of the present disclosure, where the wireless terminal 100 supports a first RAT and a second RAT. As shown in FIG. 10, the wireless terminal 100 includes a receiving module 1001 and a sending module 1003.

The receiving module 1001 is configured to receive, after the wireless terminal establishes a connection with a second RAT network, a first message sent by the second RAT network, where the first message includes content used to query a first RAT capability of the wireless terminal.

The sending module 1003 is configured to send a second message to the second RAT network after the receiving module 1001 receives the first message, where the second message is used to indicate that the wireless terminal does not support the first RAT.

Further, the sending module 1003 is specifically configured to: send the second message to the second RAT network when the wireless terminal is in a single-card dual-standby mode. Alternatively, the sending module 1003 is specifically configured to: send the second message to the second RAT network when the wireless terminal is in a single-card dual-standby mode; and send a third message to the second RAT network when the wireless terminal is in a circuit domain fallback mode, where the third message is used to indicate that the wireless terminal supports the first RAT.

Further, the wireless terminal 100 further includes:

a connecting module 1005, configured to reestablish a connection with the second RAT network before the receiving module 1001 receives the first message sent by the second RAT network and after the receiving module 1001 receives a fourth message that is sent by the second RAT network and carries a redirect indication, where the fourth message is used to instruct to redirect the wireless terminal from the second RAT network to the first RAT network.

Further, the sending module 1003 is further configured to: send a fifth message to a second RAT network management entity after the connecting module 1005 reestablishes the connection with the second RAT network, so that the second RAT network management entity triggers the second RAT network to send the first message to the wireless terminal.

Further, the connecting module 1005 is specifically configured to:

reestablish the connection with the second RAT network before the receiving module 1001 receives the first message sent by the second RAT network and when the receiving module 1001 receives the fourth message that is sent by the second RAT network and carries the redirect indication and a signal strength that is detected by the wireless terminal and corresponding to the second RAT is higher than or equal to a first threshold.

The wireless terminal illustrated in this embodiment is configured to implement the method in the foregoing embodiment shown in FIG. 1 or FIG. 2. For a specific workflow and principle and an implementation effect of the wireless terminal, refer to the embodiment shown in FIG. 1 or FIG. 2.

Another embodiment of the present disclosure further provides a wireless terminal, configured to implement the method in the foregoing embodiment shown in FIG. 1 or FIG. 2. The wireless terminal includes a processor a and a radio transceiver module a.

The radio transceiver module a is configured to perform wireless communication externally.

The processor a is configured to receive, by using the radio transceiver module a after the wireless terminal establishes a connection with a second RAT network, a first message sent by the second RAT network, where the first message includes content used to query a first RAT capability of the wireless terminal.

The processor a is further configured to send a second message to the second RAT network by using the radio transceiver module a after the first message is received, where the second message is used to indicate that the wireless terminal does not support the first RAT. Further, when the second message is sent to the second RAT network by using the radio transceiver module a, the processor a is specifically configured to: send the second message to the second RAT network by using the radio transceiver module a when the wireless terminal is in a single-card dual-standby mode. Alternatively, when sending the second message to the second RAT network by using the radio transceiver module a, the processor a is specifically configured to: send the second message to the second RAT network by using the radio transceiver module a when the wireless terminal is in a single-card dual-standby mode; and send a third message to the second RAT network by using the radio transceiver module a when the wireless terminal is in a circuit domain fallback mode, where the third message is used to indicate that the wireless terminal supports the first RAT.

Further, the processor a is further configured to: reestablish a connection with the second RAT network by using the radio transceiver module a before the first message sent by the second RAT network is received and after a fourth message that is sent by the second RAT network and carries a redirect indication is received, where the fourth message is used to instruct to redirect the wireless terminal from the second RAT network to the first RAT network.

Further, the processor a is further configured to: send a fifth message to a second RAT network management entity by using the radio transceiver module a after the connection is reestablished with the second RAT network, so that the second RAT network management entity triggers the second RAT network to send the first message to the wireless terminal.

Further, when the processor a reestablishes the connection with the second RAT network by using the radio transceiver module a, the processor a is specifically configured to: reestablish the connection with the second RAT network by using the radio transceiver module a before the first message sent by the second RAT network is received and when the fourth message that is sent by the second RAT network and carries the redirect indication is received and a signal strength that is detected by the wireless terminal and corresponding to the second RAT is higher than or equal to a first threshold.

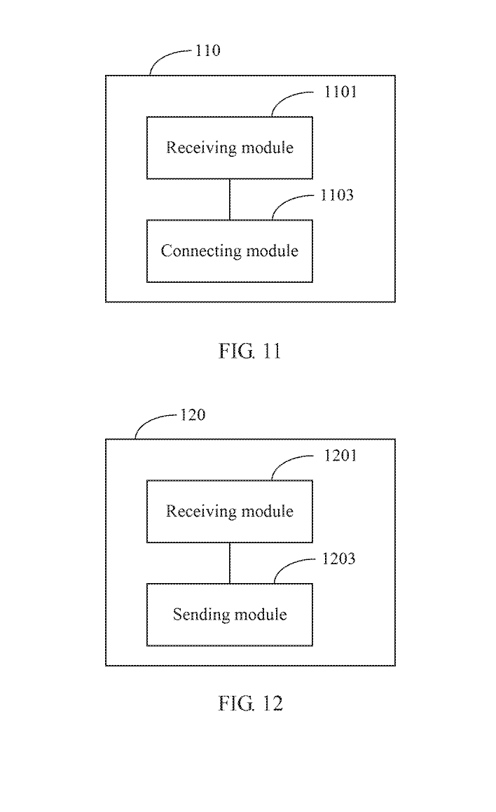

FIG. 11 is a schematic diagram of a wireless terminal according to Embodiment 11 of the present disclosure, where the wireless terminal 110 supports a first RAT and a second RAT. As shown in FIG. 11, the wireless terminal 110 includes a receiving module 1101 and a connecting module 1103.

The receiving module 1101 is configured to receive, after the wireless terminal establishes a connection with a second RAT network, a fourth message that is sent by the second RAT network and carries a redirect indication, where the fourth message is used to instruct to redirect the wireless terminal from the second RAT network to the first RAT network.

The connecting module 1103 is configured to reestablish a connection with the second RAT network after the receiving module 1101 receives the fourth message that is sent by the second RAT network and carries the redirect indication.

Further, the connecting module 1103 is specifically configured to: reestablish the connection with the second RAT network after the receiving module 1101 receives the fourth message that is sent by the second RAT network and carries the redirect indication and when the wireless terminal is in a single-card dual-standby mode. Alternatively, the connecting module 1103 is specifically configured to: reestablish the connection with the second RAT network after the receiving module 1101 receives the fourth message that is sent by the second RAT network and carries the redirect indication and when a signal strength that is detected by the wireless terminal and corresponding to the second RAT is higher than or equal to a first threshold.

The wireless terminal illustrated in this embodiment is configured to implement the method in the foregoing embodiment shown in FIG. 3 or FIG. 4. For a specific workflow and principle and an implementation effect of the wireless terminal, refer to the embodiment shown in FIG. 3 or FIG. 4.

Another embodiment of the present disclosure further provides a wireless terminal, configured to implement the method in the foregoing embodiment shown in FIG. 3 or FIG. 4. The wireless terminal includes a processor b and a radio transceiver module b.

The radio transceiver module b is configured to perform wireless communication externally.

The processor b is configured to receive, by using the radio transceiver module b after the wireless terminal establishes a connection with a second RAT network, a fourth message that is sent by the second RAT network and carries a redirect indication, where the fourth message is used to instruct to redirect the wireless terminal from the second RAT network to the first RAT network.

The processor b is further configured to reestablish a connection with the second RAT network by using the radio transceiver module b after the fourth message that is sent by the second RAT network and carries the redirect indication is received.

Further, when the processor b reestablishes the connection with the second RAT network by using the radio transceiver module b, the processor b is specifically configured to: reestablish the connection with the second RAT network by using the radio transceiver module b after the fourth message that is sent by the second RAT network and carries the redirect indication is received and when the wireless terminal is in a single-card dual-standby mode. Alternatively, when the processor b reestablishes the connection with the second RAT network by using the radio transceiver module b, the processor b is specifically configured to: reestablish the connection with the second RAT network by using the radio transceiver module b after the fourth message that is sent by the second RAT network and carries the redirect indication is received and when a signal strength that is detected by the wireless terminal and corresponding to the second RAT is higher than or equal to a first threshold.

FIG. 12 is a schematic diagram of a wireless terminal according to Embodiment 12 of the present disclosure, where the wireless terminal 120 supports a first RAT and a second RAT. As shown in FIG. 12, the wireless terminal 120 includes a receiving module 1201 and a sending module 1203.

The receiving module 1201 is configured to receive, after the wireless terminal establishes a connection with a second RAT network, a measurement configuration sent by the second RAT network, where the measurement configuration is used to configure the wireless terminal to send a measurement report to the second RAT network under a preset condition.

The sending module 1203 is configured to send a measurement report to the second RAT network after the receiving module 1201 receives the measurement configuration sent by the second RAT network and when the preset condition is met.

The measurement report includes: a processed first signal strength corresponding to the first RAT and/or a processed second signal strength corresponding to the second RAT, where the first signal strength is lower than a signal strength that is detected by the wireless terminal and corresponding to the first RAT, and the second signal strength is higher than a signal strength that is detected by the wireless terminal and corresponding to the second RAT.

Further, the sending module 1203 is specifically configured to: send the measurement report to the second RAT network when the preset condition is met, the signal strength corresponding to the second RAT is lower than or equal to a second threshold, and the signal strength corresponding to the second RAT is higher than or equal to a third threshold, where the second threshold is higher than the third threshold. Alternatively, the sending module 1203 is specifically configured to: send the measurement report to the second RAT network when the preset condition is met and the wireless terminal is in a single-card dual-standby mode.

Further,

the first signal strength is obtained in the following manner: obtaining the first signal strength by subtracting a first preset value from the signal strength that is detected by the wireless terminal and corresponding to the first RAT, or obtaining the first signal strength by subtracting a first preset amplitude from the signal strength that is detected by the wireless terminal and corresponding to the first RAT, or using a fourth threshold as the first signal strength, where the fourth threshold is lower than the signal strength that is detected by the wireless terminal and corresponding to the first RAT; and

the second signal strength is obtained in the following manner: obtaining the second signal strength by adding a second preset value to the signal strength that is detected by the wireless terminal and corresponding to the second RAT, or obtaining the second signal strength by adding a second preset amplitude to the signal strength that is detected by the wireless terminal and corresponding to the second RAT, or using a fifth threshold as the second signal strength, where the fifth threshold is higher than the signal strength that is detected by the wireless terminal and corresponding to the second RAT.

The wireless terminal illustrated in this embodiment is configured to implement the method in the foregoing embodiment shown in FIG. 5 or FIG. 6. For a specific workflow and principle and an implementation effect of the wireless terminal, refer to the embodiment shown in FIG. 5 or FIG. 6.

Another embodiment of the present disclosure further provides a wireless terminal, configured to implement the method in the foregoing embodiment shown in FIG. 5 or FIG. 6. The wireless terminal includes a processor c and a radio transceiver module c.

The radio transceiver module c is configured to perform wireless communication externally.

The processor c is configured to receive, by using the radio transceiver module c after the wireless terminal establishes a connection with a second RAT network, a measurement configuration sent by the second RAT network, where the measurement configuration is used to configure the wireless terminal to send a measurement report to the second RAT network under a preset condition.

The processor c is configured to send a measurement report to the second RAT network by using the radio transceiver module c after the measurement configuration sent by the second RAT network is received and when the preset condition is met.

The measurement report includes: a processed first signal strength corresponding to the first RAT and/or a processed second signal strength corresponding to the second RAT, where the first signal strength is lower than a signal strength that is detected by the wireless terminal and corresponding to the first RAT, and the second signal strength is higher than a signal strength that is detected by the wireless terminal and corresponding to the second RAT.

Further, when the processor c sends the measurement report to the second RAT network by using the radio transceiver module c, the processor c is specifically configured to: send the measurement report to the second RAT network by using the radio transceiver module c when the preset condition is met, the signal strength corresponding to the second RAT is lower than or equal to a second threshold, and the signal strength corresponding to the second RAT is higher than or equal to a third threshold, where the second threshold is higher than the third threshold. Alternatively, when the processor c sends the measurement report to the second RAT network by using the radio transceiver module c, the processor c is specifically configured to: send the measurement report to the second RAT network by using the radio transceiver module c when the preset condition is met and the wireless terminal is in a single-card dual-standby mode.

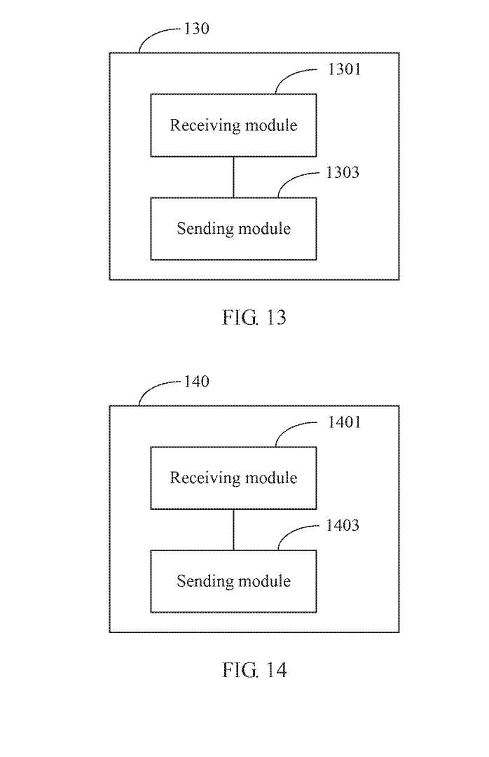

FIG. 13 is a schematic diagram of a wireless terminal according to Embodiment 13 of the present disclosure, where the wireless terminal 130 supports a first RAT and a second RAT. As shown in FIG. 13, the wireless terminal 130 includes a receiving module 1301 and a sending module 1303.

The receiving module 1301 is configured to receive, after the wireless terminal establishes a connection with a second RAT network, a measurement configuration sent by the second RAT network, where the measurement configuration is used to configure the wireless terminal to send a measurement report to the second RAT network under a preset condition, where the preset condition is: when a signal strength that is detected by the wireless terminal and corresponding to the first RAT is higher than or equal to a sixth threshold, the wireless terminal sends a measurement report corresponding to the first RAT, where the measurement report corresponding to the first RAT includes the signal strength that is detected by the wireless terminal and corresponding to the first RAT.

The sending module 1303 is configured to send the measurement report corresponding to the first RAT to the second RAT network after the receiving module 1301 receives the measurement configuration and when the signal strength that is detected by the wireless terminal and corresponding to the first RAT is higher than or equal to a seventh threshold, where the seventh threshold is higher than the sixth threshold.

Specifically, the seventh threshold is a preset fixed value; or the seventh threshold is the sixth threshold plus a third preset value; or the seventh threshold is the sixth threshold plus a third preset amplitude.

The wireless terminal illustrated in this embodiment is configured to implement the method in the foregoing embodiment shown in FIG. 7. For a specific workflow and principle and an implementation effect of the wireless terminal, refer to the embodiment shown in FIG. 7.

Another embodiment of the present disclosure further provides a wireless terminal, configured to implement the method in the foregoing embodiment shown in FIG. 7. The wireless terminal includes a processor d and a radio transceiver module d.

The radio transceiver module d is configured to perform wireless communication externally.

The processor d is configured to receive, by using the radio transceiver module d after the wireless terminal establishes a connection with a second RAT network, a measurement configuration sent by the second RAT network, where the measurement configuration is used to configure the wireless terminal to send a measurement report to the second RAT network under a preset condition, where the preset condition is: when a signal strength that is detected by the wireless terminal and corresponding to the first RAT is higher than or equal to a sixth threshold, the wireless terminal sends a measurement report corresponding to the first RAT, where the measurement report corresponding to the first RAT includes the signal strength that is detected by the wireless terminal and corresponding to the first RAT.

The processor d is further configured to send, by using the radio transceiver module d, the measurement report corresponding to the first RAT to the second RAT network after the measurement configuration is received and when the signal strength that is detected by the wireless terminal and corresponding to the first RAT is higher than or equal to a seventh threshold, where the seventh threshold is higher than the sixth threshold.

Specifically, the seventh threshold is a preset fixed value; or the seventh threshold is the sixth threshold plus a third preset value; or the seventh threshold is the sixth threshold plus a third preset amplitude.

FIG. 14 is a schematic diagram of a wireless terminal according to Embodiment 14 of the present disclosure, where the wireless terminal 140 supports a first RAT and a second RAT. As shown in FIG. 14, the wireless terminal 140 includes a receiving module 1401 and a sending module 1403.

The receiving module 1401 is configured to receive, after the wireless terminal establishes a connection with a second RAT network, a measurement configuration sent by the second RAT network, where the measurement configuration is used to configure the wireless terminal to send a measurement report to the second RAT network under a preset condition, where the preset condition is: when a signal strength that is detected by the wireless terminal and corresponding to the second RAT is lower than or equal to an eighth threshold, the wireless terminal sends a measurement report corresponding to the second RAT, where the measurement report corresponding to the second RAT includes the signal strength that is detected by the wireless terminal and corresponding to the second RAT.

The sending module 1403 is configured to send the measurement report corresponding to the second RAT to the second RAT network after the receiving module 1401 receives the measurement configuration and when the signal strength that is detected by the wireless terminal and corresponding to the second RAT is lower than or equal to a ninth threshold, where the ninth threshold is lower than the eighth threshold.

Specifically, the ninth threshold is a preset fixed value; or the ninth threshold is the eighth threshold minus a fourth preset value; or the ninth threshold is the eighth threshold minus a fourth preset amplitude.

The wireless terminal illustrated in this embodiment is configured to implement the method in the foregoing embodiment shown in FIG. 8. For a specific workflow and principle and an implementation effect of the wireless terminal, refer to the embodiment shown in FIG. 8.

Another embodiment of the present disclosure further provides a wireless terminal, configured to implement the method in the foregoing embodiment shown in FIG. 8. The wireless terminal includes a processor e and a radio transceiver module e.

The radio transceiver module e is configured to perform wireless communication externally.

The processor e is configured to receive, by using the radio transceiver module e after the wireless terminal establishes a connection with a second RAT network, a measurement configuration sent by the second RAT network, where the measurement configuration is used to configure the wireless terminal to send a measurement report to the second RAT network under a preset condition, where the preset condition is: when a signal strength that is detected by the wireless terminal and corresponding to the second RAT is lower than or equal to an eighth threshold, the wireless terminal sends a measurement report corresponding to the second RAT, where the measurement report corresponding to the second RAT includes the signal strength that is detected by the wireless terminal and corresponding to the second RAT.

The processor e is further configured to send the measurement report corresponding to the second RAT to the second RAT network by using the radio transceiver module e after the measurement configuration is received and when the signal strength that is detected by the wireless terminal and corresponding to the second RAT is lower than or equal to a ninth threshold, where the ninth threshold is lower than the eighth threshold.

Specifically, the ninth threshold is a preset fixed value; or the ninth threshold is the eighth threshold minus a fourth preset value; or the ninth threshold is the eighth threshold minus a fourth preset amplitude.

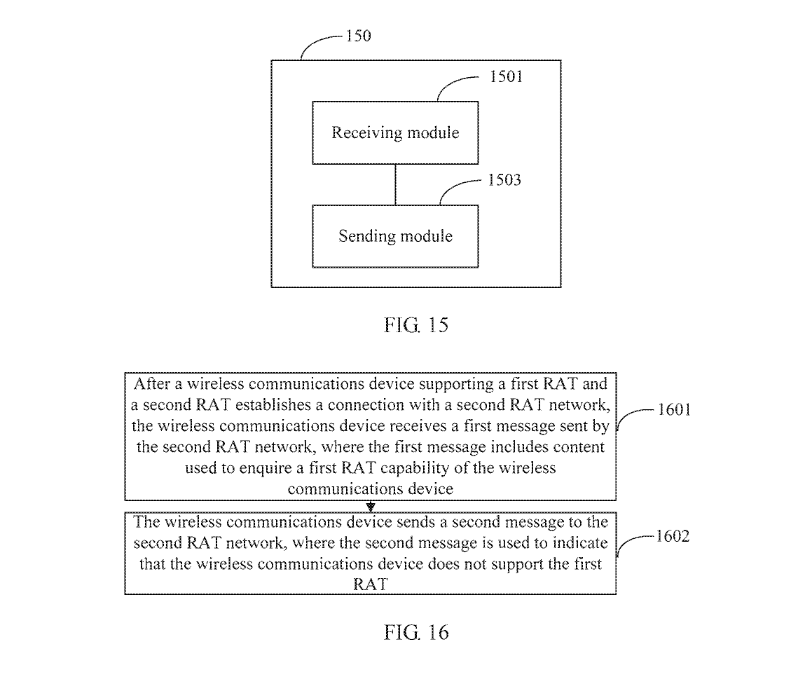

FIG. 15 is a schematic diagram of a wireless terminal according to Embodiment 15 of the present disclosure, where the wireless terminal 150 supports a first RAT and a second RAT. As shown in FIG. 15, the wireless terminal 150 includes a receiving module 1501 and a sending module 1503.

The receiving module 1501 is configured to receive, after the wireless terminal supporting the first RAT and second RAT establishes a connection with a second RAT network, a measurement configuration sent by the second RAT network, where the measurement configuration is used to configure the wireless terminal to send a measurement report to the second RAT network under a preset condition, where the measurement report includes signal strengths that are detected by the wireless terminal and respectively corresponding to the first RAT and second RAT.

The sending module 1503 is configured to: after the receiving module 1501 receives the measurement configuration and when the preset condition is met, send a measurement report corresponding to the second RAT to the second RAT network, and skip sending a measurement report corresponding to the first RAT to the second RAT network.

Further, the sending module 1503 is specifically configured to: when the wireless terminal is in a single-card dual-standby mode and the preset condition is met, send the measurement report corresponding to the second RAT to the second RAT network, and skip sending the measurement report corresponding to the first RAT to the second RAT network.

The wireless terminal illustrated in this embodiment is configured to implement the method in the foregoing embodiment shown in FIG. 9. For a specific workflow and principle and an implementation effect of the wireless terminal, refer to the embodiment shown in FIG. 9.

Another embodiment of the present disclosure further provides a wireless terminal, configured to implement the method in the foregoing embodiment shown in FIG. 9. The wireless terminal includes a processor f and a radio transceiver module f.

The radio transceiver module f is configured to perform wireless communication externally.

The processor f is configured to receive, by using the radio transceiver module f after the wireless terminal supporting a first RAT and a second RAT establishes a connection with a second RAT network, a measurement configuration sent by the second RAT network, where the measurement configuration is used to configure the wireless terminal to send a measurement report to the second RAT network under a preset condition, where the measurement report includes signal strengths that are detected by the wireless terminal and respectively corresponding to the first RAT and second RAT.

The processor f is further configured to: after the measurement configuration is received and when the preset condition is met, send, by using the radio transceiver module f, a measurement report corresponding to the second RAT to the second RAT network, and skip sending a measurement report corresponding to the first RAT to the second RAT network.

Further, when the processor f sends the measurement report by using the radio transceiver module f, the processor f is specifically configured to: when the wireless terminal is in a single-card dual-standby mode and the preset condition is met, send the measurement report corresponding to the second RAT to the second RAT network by using the radio transceiver module f, and skip sending the measurement report corresponding to the first RAT to the second RAT network.

In the wireless terminal provided by the embodiments of the present disclosure, the radio transceiver module may be, for example, a radio transceiver (such as a radio frequency circuit) in the wireless terminal, and the processor may include, for example, a wireless communications device in the wireless terminal, where the wireless communications device may include a Modem (modem) chip, or may also include a Modem chip and a CPU, or include a Modem chip and a digital signal processor (Digital Signal Processor, DSP for short), or include a Modem chip and an AP (Application Processor, application processor) chip. Using an example in which a mobile terminal is a mobile phone for description, the mobile phone may include: parts such as an RF (radio frequency, radio frequency) circuit, a memory, an input unit, a display unit, a gravity sensor, an audio circuit, a processor, and a power supply. A person skilled in the prior art may understand that a structure of the mobile phone does not constitute a limitation on the mobile phone, where the mobile phone may include more or fewer parts, or combine some parts, or have different arrangements of parts.

It should be noted that the method provided by any one of the foregoing embodiments of the present disclosure may be performed by the wireless terminal, or may also be performed by the wireless communications device in the wireless terminal. The wireless communications device may include a circuit or an integrated circuit (IC for short), for example, may include a package of a single IC, or may also include a package of multiple ICs that are connected and have same functions or different functions. For example, the wireless communications device may include a Modem (modem) chip, or may also include a Modem chip and a CPU, or include a Modem chip and a digital signal processor (DSP for short), or include a Modem chip and an AP (Application Processor, application processor) chip.

FIG. 16 is a schematic flowchart of a wireless communication method according to Embodiment 16 of the present disclosure. As shown in FIG. 16, the method may include:

Step 1601: After a wireless communications device supporting a first RAT and a second RAT establishes a connection with a second RAT network, the wireless communications device receives a first message sent by the second RAT network, where the first message includes content used to query a first RAT capability of the wireless communications device.

Step 1602: The wireless communications device sends a second message to the second RAT network, where the second message is used to indicate that the wireless communications device does not support the first RAT.

Optionally, in another implementation manner, the wireless communications device may first determine a mode of the wireless communications device before sending the second message to the second RAT network. The wireless communications device sends the second message to the second RAT network when the wireless communications device is in a dual-standby mode. The wireless communications device sends a third message to the second RAT network when the wireless communications device is in a circuit domain fallback mode, where the third message is used to indicate that the wireless communications device supports the first RAT.

Optionally, the following manner may be used to determine whether the wireless communications device is in the dual-standby mode: when a PLMN identifier of a second RAT cell on which the wireless communications device camps is in an operator controlled PLMN selector list stored by the wireless communications device, it indicates that the wireless communications device is in the dual-standby mode.

Specifically, the second message may not include the first RAT capability; or the second message may include an identifier used to indicate that the wireless communications device does not support the first RAT.

Further, the method may further include: after the wireless communications device establishes the connection with the second RAT network, skipping, by the wireless communications device, detecting a signal strength corresponding to the first RAT.

Further, before the wireless communications device receives the first message sent by the second RAT network, the method may further include:

reestablishing, by the wireless communications device, a connection with the second RAT network after the wireless communications device receives a fourth message that is sent by the second RAT network and carries a redirect indication, where the fourth message is used to instruct to redirect the wireless communications device from the second RAT network to the first RAT network; and

sending, by the wireless communications device, a fifth message to a second RAT network management entity, so that the second RAT network management entity triggers the second RAT network to send the first message to the wireless communications device.

The reestablishing, by the wireless communications device, a connection with the second RAT network after the wireless communications device receives a fourth message that is sent by the second RAT network and carries a redirect indication, may specifically include:

reestablishing, by the wireless communications device, the connection with the second RAT network when the wireless communications device receives the fourth message that is sent by the second RAT network and carries the redirect indication and a signal strength that is detected by the wireless communications device and corresponding to the second RAT is higher than or equal to a first threshold.

Further, the connection established by the wireless communications device with the second RAT network may be an RRC connection.

A main difference between the method provided by this embodiment of the present disclosure and the method provided by the embodiment shown in FIG. 1 or FIG. 2 lies in that the methods are performed by different entities. Only some main steps are described in this embodiment. For a specific process of the method, refer to the descriptions in the embodiments shown in FIG. 1 and FIG. 2.

In this embodiment of the present disclosure, after a wireless communications device supporting a first RAT and a second RAT establishes a connection with a second RAT network, the wireless communications device may receive a first message that is sent by the second RAT network and used to query a first RAT capability of the wireless communications device; and the wireless communications device sends a second message to the second RAT network, where the second message is used to indicate that the wireless communications device does not support the first RAT. Because the wireless communications device reports that the wireless communications device does not support the first RAT to the second RAT network, the second RAT network does not instruct to change a wireless terminal in which the wireless communications device is located, to the first RAT. Therefore, the wireless terminal in which the wireless communications device is located may work in the second RAT for a long time, the number of changes of the wireless terminal between the first RAT and the second RAT is reduced, network load is reduced, and user experience is enhanced.

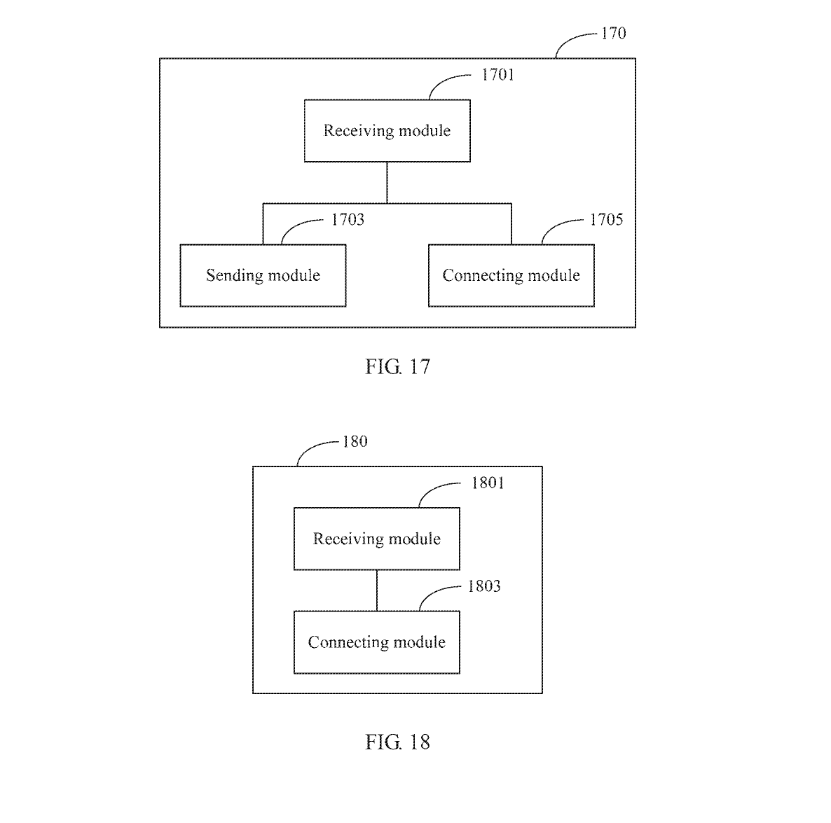

FIG. 17 is a schematic diagram of a wireless communications device according to Embodiment 17 of the present disclosure, where the wireless communications device 170 supports a first RAT and a second RAT. As shown in FIG. 17, the wireless communications device 170 includes a receiving module 1701 and a sending module 1703.

The receiving module 1701 is configured to receive, after the wireless communications device establishes a connection with a second RAT network, a first message sent by the second RAT network, where the first message includes content used to query a first RAT capability of the wireless communications device.

The sending module 1703 is configured to send a second message to the second RAT network after the receiving module 1701 receives the first message, where the second message is used to indicate that the wireless communications device does not support the first RAT.

Further, the sending module 1703 is specifically configured to: send the second message to the second RAT network when the wireless communications device is in a single-card dual-standby mode. Alternatively, the sending module 1703 is specifically configured to: send the second message to the second RAT network when the wireless communications device is in a single-card dual-standby mode; and send a third message to the second RAT network when the wireless communications device is in a circuit domain fallback mode, where the third message is used to indicate that the wireless communications device supports the first RAT.

Further, the wireless communications device 170 further includes:

a connecting module 1705, configured to reestablish a connection with the second RAT network before the receiving module 1701 receives the first message sent by the second RAT network and after the receiving module 1701 receives a fourth message that is sent by the second RAT network and carries a redirect indication, where the fourth message is used to instruct to redirect the wireless communications device from the second RAT network to the first RAT network.

Further, the sending module 1703 is further configured to: send a fifth message to a second RAT network management entity after the connecting module 1705 reestablishes the connection with the second RAT network, so that the second RAT network management entity triggers the second RAT network to send the first message to the wireless communications device.

Further, the connecting module 1705 is specifically configured to:

reestablish the connection with the second RAT network before the receiving module 1701 receives the first message sent by the second RAT network and when the receiving module 1701 receives the fourth message that is sent by the second RAT network and carries the redirect indication and a signal strength that is detected by the wireless communications device and corresponding to the second RAT is higher than or equal to a first threshold.

The wireless communications device illustrated in this embodiment is configured to implement the method in the foregoing embodiment shown in FIG. 16. For a specific workflow and principle and an implementation effect of the wireless communications device, refer to the embodiment shown in FIG. 16.

FIG. 18 is a schematic diagram of a wireless communications device according to Embodiment 18 of the present disclosure, where the wireless communications device 180 supports a first RAT and a second RAT. As shown in FIG. 18, the wireless communications device 180 includes a receiving module 1801 and a connecting module 1803.

The receiving module 1801 is configured to receive, after the wireless communications device establishes a connection with a second RAT network, a fourth message that is sent by the second RAT network and carries a redirect indication, where the fourth message is used to instruct to redirect the wireless communications device from the second RAT network to the first RAT network.

The connecting module 1803 is configured to reestablish a connection with the second RAT network after the receiving module 1801 receives the fourth message that is sent by the second RAT network and carries the redirect indication.

Further, the connecting module 1803 is specifically configured to: reestablish the connection with the second RAT network after the receiving module 1801 receives the fourth message that is sent by the second RAT network and carries the redirect indication and when the wireless communications device is in a single-card dual-standby mode. Alternatively, the connecting module 1803 is specifically configured to: reestablish the connection with the second RAT network after the receiving module 1801 receives the fourth message that is sent by the second RAT network and carries the redirect indication and when a signal strength that is detected by the wireless communications device and corresponding to the second RAT is higher than or equal to a first threshold.

The wireless communications device illustrated in this embodiment is configured to implement a wireless communication method, where a main difference between the wireless communication method and the method provided by the embodiment shown in FIG. 3 or FIG. 4 lies in that the methods are performed by different entities. For a workflow and principle and an implementation effect of the wireless communications device, refer to the embodiment shown in FIG. 3 or FIG. 4.

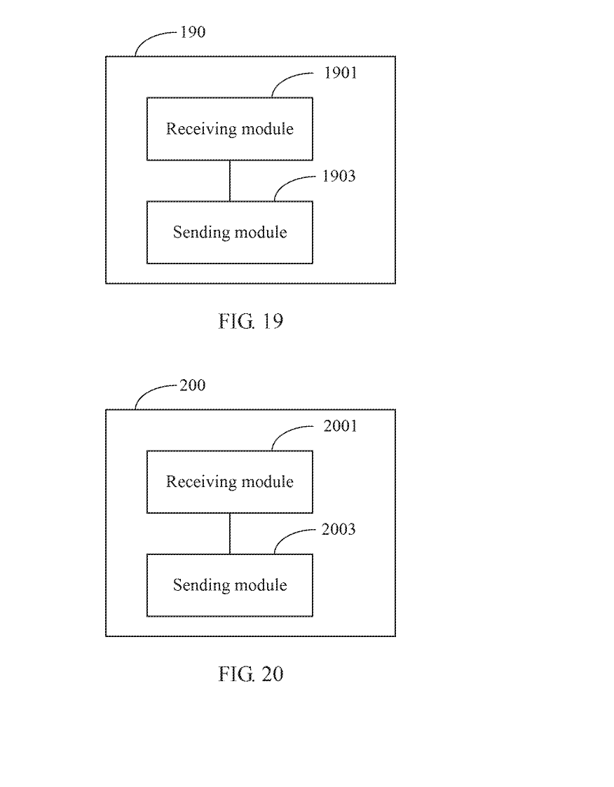

FIG. 19 is a schematic diagram of a wireless communications device according to Embodiment 19 of the present disclosure, where the wireless communications device 190 supports a first RAT and a second RAT. As shown in FIG. 19, the wireless communications device 190 includes a receiving module 1901 and a sending module 1903.

The receiving module 1901 is configured to receive, after the wireless communications device establishes a connection with a second RAT network, a measurement configuration sent by the second RAT network, where the measurement configuration is used to configure the wireless communications device to send a measurement report to the second RAT network under a preset condition.

The sending module 1903 is configured to send a measurement report to the second RAT network after the receiving module 1901 receives the measurement configuration sent by the second RAT network and when the preset condition is met.

The measurement report includes: a processed first signal strength corresponding to the first RAT and/or a processed second signal strength corresponding to the second RAT, where the first signal strength is lower than a signal strength that is detected by the wireless communications device and corresponding to the first RAT, and the second signal strength is higher than a signal strength that is detected by the wireless communications device and corresponding to the second RAT.

Further, the sending module 1903 is specifically configured to: send the measurement report to the second RAT network when the preset condition is met, the signal strength corresponding to the second RAT is lower than or equal to a second threshold, and the signal strength corresponding to the second RAT is higher than or equal to a third threshold, where the second threshold is higher than the third threshold. Alternatively, the sending module 1903 is specifically configured to: send the measurement report to the second RAT network when the preset condition is met and the wireless communications device is in a single-card dual-standby mode.

Further,

the first signal strength is obtained in the following manner: obtaining the first signal strength by subtracting a first preset value from the signal strength that is detected by the wireless communications device and corresponding to the first RAT, or obtaining the first signal strength by subtracting a first preset amplitude from the signal strength that is detected by the wireless communications device and corresponding to the first RAT, or using a fourth threshold as the first signal strength, where the fourth threshold is lower than the signal strength that is detected by the wireless communications device and corresponding to the first RAT; and

the second signal strength is obtained in the following manner: obtaining the second signal strength by adding a second preset value to the signal strength that is detected by the wireless communications device and corresponding to the second RAT, or obtaining the second signal strength by adding a second preset amplitude to the signal strength that is detected by the wireless communications device and corresponding to the second RAT, or using a fifth threshold as the second signal strength, where the fifth threshold is higher than the signal strength that is detected by the wireless communications device and corresponding to the second RAT.

The wireless communications device illustrated in this embodiment is configured to implement a wireless communication method, where a main difference between the wireless communication method and the method provided by the embodiment shown in FIG. 5 or FIG. 6 lies in that the methods are performed by different entities. For a workflow and principle and an implementation effect of the wireless communications device, refer to the embodiment shown in FIG. 5 or FIG. 6.

FIG. 20 is a schematic diagram of a wireless communications device according to Embodiment 20 of the present disclosure, where the wireless communications device 200 supports a first RAT and a second RAT. As shown in FIG. 20, the wireless communications device 200 includes a receiving module 2001 and a sending module 2003.

The receiving module 2001 is configured to receive, after the wireless communications device establishes a connection with a second RAT network, a measurement configuration sent by the second RAT network, where the measurement configuration is used to configure the wireless communications device to send a measurement report to the second RAT network under a preset condition, where the preset condition is: when a signal strength that is detected by the wireless communications device and corresponding to the first RAT is higher than or equal to a sixth threshold, the wireless communications device sends a measurement report corresponding to the first RAT, where the measurement report corresponding to the first RAT includes the signal strength that is detected by the wireless communications device and corresponding to the first RAT.

The sending module 2003 is configured to send the measurement report corresponding to the first RAT to the second RAT network after the receiving module 2001 receives the measurement configuration and when the signal strength that is detected by the wireless communications device and corresponding to the first RAT is higher than or equal to a seventh threshold, where the seventh threshold is higher than the sixth threshold.

Specifically, the seventh threshold is a preset fixed value; or the seventh threshold is the sixth threshold plus a third preset value; or the seventh threshold is the sixth threshold plus a third preset amplitude.

The wireless communications device illustrated in this embodiment is configured to implement a wireless communication method, where a main difference between the wireless communication method and the method provided by the embodiment shown in FIG. 7 lies in that the methods are performed by different entities. For a workflow and principle and an implementation effect of the wireless communications device, refer to the embodiment shown in FIG. 7.

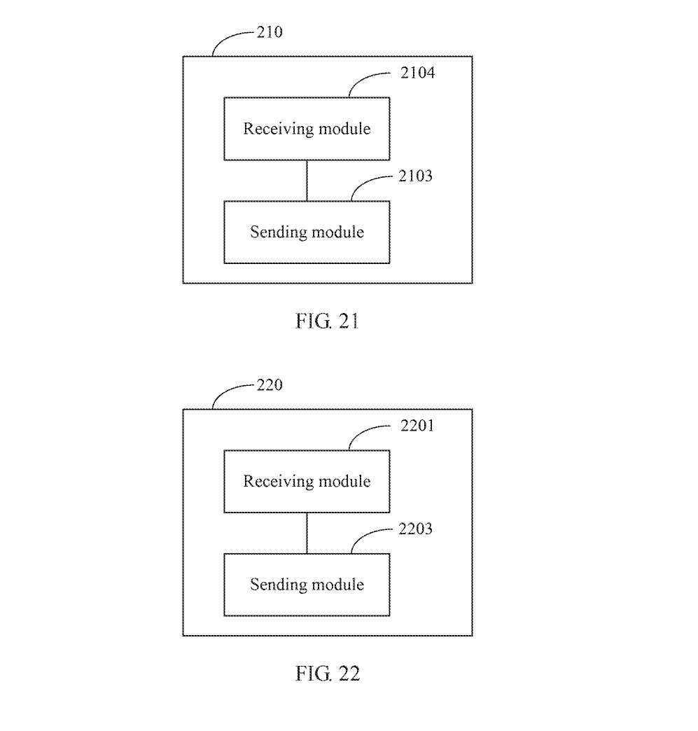

FIG. 21 is a schematic diagram of a wireless communications device according to Embodiment 21 of the present disclosure, where the wireless communications device 210 supports a first RAT and a second RAT. As shown in FIG. 21, the wireless communications device 210 includes a receiving module 2101 and a sending module 2103.

The receiving module 2101 is configured to receive, after the wireless communications device establishes a connection with a second RAT network, a measurement configuration sent by the second RAT network, where the measurement configuration is used to configure the wireless communications device to send a measurement report to the second RAT network under a preset condition, where the preset condition is: when a signal strength that is detected by the wireless communications device and corresponding to the second RAT is lower than or equal to an eighth threshold, the wireless communications device sends a measurement report corresponding to the second RAT, where the measurement report corresponding to the second RAT includes the signal strength that is detected by the wireless communications device and corresponding to the second RAT.

The sending module 2103 is configured to send the measurement report corresponding to the second RAT to the second RAT network after the receiving module 2101 receives the measurement configuration and when the signal strength that is detected by the wireless communications device and corresponding to the second RAT is lower than or equal to a ninth threshold, where the ninth threshold is lower than the eighth threshold.

Specifically, the ninth threshold is a preset fixed value; or the ninth threshold is the eighth threshold minus a fourth preset value; or the ninth threshold is the eighth threshold minus a fourth preset amplitude.

The wireless communications device illustrated in this embodiment is configured to implement a wireless communication method, where a main difference between the wireless communication method and the method provided by the embodiment shown in FIG. 8 lies in that the methods are performed by different entities. For a workflow and principle and an implementation effect of the wireless communications device, refer to the embodiment shown in FIG. 8.

FIG. 22 is a schematic diagram of a wireless communications device according to Embodiment 22 of the present disclosure, where the wireless communications device 220 supports a first RAT and a second RAT. As shown in FIG. 22, the wireless communications device 220 includes a receiving module 2201 and a sending module 2203.

The receiving module 2201 is configured to receive, after the wireless communications device supporting the first RAT and second RAT establishes a connection with a second RAT network, a measurement configuration sent by the second RAT network, where the measurement configuration is used to configure the wireless communications device to send a measurement report to the second RAT network under a preset condition, where the measurement report includes signal strengths that are detected by the wireless communications device and respectively corresponding to the first RAT and second RAT.

The sending module 2203 is configured to: after the receiving module 2201 receives the measurement configuration and when the preset condition is met, send a measurement report corresponding to the second RAT to the second RAT network, and skip sending a measurement report corresponding to the first RAT to the second RAT network.

Further, the sending module 2203 is specifically configured to: when the wireless communications device is in a single-card dual-standby mode and the preset condition is met, send the measurement report corresponding to the second RAT to the second RAT network, and skip sending the measurement report corresponding to the first RAT to the second RAT network.

The wireless communications device illustrated in this embodiment is configured to implement a wireless communication method, where a main difference between the wireless communication method and the method provided by the embodiment shown in FIG. 9 lies in that the methods are performed by different entities. For a workflow and principle and an implementation effect of the wireless communications device, refer to the embodiment shown in FIG. 9.

A person of ordinary skill in the art may understand that all or a part of the processes of the methods in the embodiments may be implemented by a computer program instructing relevant hardware. The program may be stored in a computer readable storage medium. When the program runs, the processes of the methods in the embodiments are performed. The foregoing storage medium may include: a magnetic disk, an optical disc, a read-only memory (ROM), or a random access memory (RAM).

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1-66. (canceled)

67. A wireless communication method, wherein the method comprises:
establishing, by a wireless communications device, a connection with a second radio access technology (RAT) network, the wireless communications device supporting a first RAT and the second RAT;
receiving, by the wireless communications device, a first message sent by the second RAT network, wherein the first message comprises content used to query a first RAT capability of the wireless communications device; and
sending, by the wireless communications device, a second message to the second RAT network, wherein the second message is used to indicate that the wireless communications device does not support the first RAT.

68. The method according to claim 67, wherein the step of sending the second message to the second RAT network comprises:
sending, by the wireless communications device, the second message to the second RAT network when the wireless communications device is in a dual-standby mode.

69. The method according to claim 68, further comprising:
sending, by the wireless communications device, a third message to the second RAT network when the wireless communications device is in a circuit domain fallback mode, wherein the third message is used to indicate that the wireless communications device supports the first RAT.

70. The method according to claim 68, wherein the step of sending the second message to the second RAT network when the wireless communications device is in the dual-standby mode comprises:
when a public land mobile network (PLMN) identifier of a second RAT cell on which the wireless communications device camps is in an operator controlled PLMN selector list stored by the wireless communications device, sending, by the wireless communications device, the second message to the second RAT network.

71. The method according to claim 69, wherein the step of sending the third message comprises:
when a public land mobile network (PLMN) identifier of a second RAT cell on which the wireless communications device camps is not in an operator controlled PLMN selector list stored by the wireless communications device, sending, by the wireless communications device, the third message to the second RAT network.

72. The method according to claim 67, wherein: the second message does not comprise a first RAT capability.

73. The method according to claim 67, wherein: the second message comprises an identifier used to indicate that the wireless communications device does not support the first RAT.

74. The method according to claim 67, wherein the method further comprises:
after the wireless communications device establishes the connection with the second RAT network, skipping, by the wireless communications device, a detection of a signal strength corresponding to the first RAT.

75. The method according to claim 67, wherein before the step of receiving, the method further comprises:
reestablishing, by the wireless communications device, a connection with the second RAT network after the wireless communications device receives a fourth message that is sent by the second RAT network and carries a redirect indication, wherein the fourth message is used to instruct to redirect the wireless communications device from the second RAT network to the first RAT network; and
sending, by the wireless communications device, a fifth message to a second RAT network management entity, so that the second RAT network management entity triggers the second RAT network to send the first message to the wireless communications device.

76. The method according to claim 75, wherein the step of reestablishing comprises:
reestablishing, by the wireless communications device, the connection with the second RAT network when the wireless communications device receives the fourth message that is sent by the second RAT network and carries the redirect indication and a signal strength that is detected by the wireless communications device and corresponding to the second RAT is higher than or equal to a first threshold.

77. The method according to claim 67, wherein
the first RAT comprises a 2G packet switched domain or 3G, and the second RAT is 4G.

78. The method according to claim 67, wherein the connection established by the wireless communications device with the second RAT network is a radio resource control (RRC) connection.

79. A wireless terminal, wherein the wireless terminal supports a first radio access technology RAT and a second RAT, and the wireless terminal comprises a radio transceiver module and a processor, wherein:
the radio transceiver module is configured to perform wireless communication externally;
the processor is configured to establish, by using the radio transceiver module, a connection with the second RAT network;
the processor is further configured to receive, by using the radio transceiver module, a first message sent by the second RAT network, wherein the first message comprises content used to query a first RAT capability of the wireless terminal; and
the processor is further configured to send a second message to the second RAT network by using the radio transceiver module, wherein the second message is used to indicate that the wireless terminal does not support the first RAT.

80. The wireless terminal according to claim 79, wherein when the second message is sent to the second RAT network by using the radio transceiver module, the processor is configured to: send the second message to the second RAT network by using the radio transceiver module when the wireless terminal is in a dual-standby mode.

81. The wireless terminal according to claim 80, wherein the processor is further configured to:
send a third message to the second RAT network by using the radio transceiver module when the wireless terminal is in a circuit domain fallback mode, wherein the third message is used to indicate that the wireless terminal supports the first RAT.

82. The wireless terminal according to claim 79, wherein the processor is further configured to:
reestablish a connection with the second RAT network before the first message sent by the second RAT network is received by using the radio transceiver module and after a fourth message that is sent by the second RAT network and carries a redirect indication is received by using the radio transceiver module, wherein the fourth message is used to instruct to redirect the wireless terminal from the second RAT network to the first RAT network; and
send a fifth message to a second RAT network management entity by using the radio transceiver module after the connection is reestablished with the second RAT network, so that the second RAT network management entity triggers the second RAT network to send the first message to the wireless terminal.

83. The wireless terminal according to claim 82, wherein when the connection is reestablished with the second RAT network, the processor is configured to:
reestablish the connection with the second RAT network when a signal strength corresponding to the second RAT is higher than or equal to a first threshold.

84. The wireless terminal according to claim 79, wherein the first RAT comprises a 2G packet switched domain or 3G, and the second RAT is 4G.

85. The wireless terminal according to claim 79, wherein the connection established by the wireless terminal with the second RAT network is a radio resource control (RRC) connection.

86. The wireless terminal according to claim 79, wherein the processor includes a wireless communication device.
